(19) United States
(12) Patent Application Publication
(10) Pub. No.: US 2011/0074899 A1
(43) Pub. Date: Mar. 31, 2011

(54) PRINTING PAPER SEASONING APPARATUS AND METHOD, AND INKJET RECORDING APPARATUS

(76) Inventors: Yuhei CHIWATA, Kanagawa-ken (JP); Junichi Endou, Kanagawa-ken (JP)

(21) Appl. No.: 12/889,515

(22) Filed: Sep. 24, 2010

(30) Foreign Application Priority Data
Sep. 25, 2009 (JP) 2009-221167

(51) Int. Cl. B41J 2/01

(52) U.S. Cl. 347/104

(57) ABSTRACT

In a printing paper seasoning apparatus, sheets of paper are placed in a stack in a paper accommodating section. A direction to which convex sides of curled sheets face is taken as a curl direction. An air flow is controlled in such a manner that during an initial period of an air blowing, the air flow supplied to one of the upper and lower portions of the paper accommodating section on a side opposite from the curl direction is greater than the air flow supplied to the other of the upper and lower portions on a side of the curl direction, and during a latter period of the air blowing, the air flow supplied to the one of the upper and lower portions on the side opposite from the curl direction is reduced and the air flow supplied to the other on the side of the curl direction is increased.

### BACKGROUND OF THE INVENTION

1. Field of the Invention

The present invention relates to a printing paper seasoning apparatus and method, and an inkjet recording apparatus, and more particularly, to seasoning technology which reduces expansion/contraction and deformation of the paper having been printed by conditioning the paper close to the ambient temperature and humidity.

2. Description of the Related Art

In a printing system, immediately after ink has been deposited on paper, expansion and contraction of the paper occurs due to the difference in moisture content resulting from the light and dark tones of the ink (i.e., different ink volumes) in the image region. This problem is especially conspicuous in a system which prints onto normal paper using water-based ink. Moreover, when carrying out double-side printing, normally, after completing printing on one side (the front surface), printing is carried out on the opposite side (the rear surface); however, immediately after printing on the front surface, there is significant expansion of the paper and a problem arises in that deviation occurs in the size and position of the images printed respectively on the front surface and the rear surface (i.e., there is mismatch in register on the front and rear surfaces).

In the case of single-side printing also, and not only double-side printing, there is a problem of deterioration of printing quality due to the occurrence of curl or cockling as a result of deformation of the paper as described above. Furthermore, there is also a problem of causing adverse effects on subsequent processing steps, such as a binding process, which are carried out after the printing step.

Japanese Patent Application Publication No. 2001-063019 discloses a printing apparatus having a composition to address the problem of scratches occurring in an image when the image rubs against guide members, and the like, if the drying of the front surface is insufficient when performing double-side printing. The printing apparatus has a composition in which a printed matter after printing on one side thereof (front surface) is output to the exterior of the printing apparatus, and drying is promoted by means of a heater or hot air flow on an output tray outside the printing apparatus, whereupon printing of the rear surface is carried out.

Japanese Patent Application Publication No. 08-175690 discloses a paper jogger in which an air nozzle is arranged movably in the vertical direction by an end side of a stack of printing paper sheets, and the paper sheets are separated by blowing pressurized air from the air nozzle. Moreover, in order to prevent displacement of the paper sheets at the end of air blowing, the top surface of the stacked paper is pressed with a pressing clamp at the end of air blowing.

Japanese Patent Application Publication No. 10-297813 discloses a paper jogger which is provided with side walls surrounding the four end sides of a stack of printing paper sheets, and at least one of the side walls has an air blowing port, whereby air can be introduced from the air blowing port into the stacked paper sheets efficiently while preventing dispersion of the air to the exterior of the stacked paper sheets. Moreover, at the end of air blowing, the air is sucked from between the paper sheets so that the paper sheets are orderly stacked without scattering.

However, in the above-described related art, it is difficult to rapidly and uniformly season (i.e., to adapt the paper to the ambient humidity) the stack of paper sheets having been printed. Furthermore, depending on the image contents, the amount of ink deposited may become greater and in accordance with this, significant curl occurs in the printed sheets. If so-called “reverse curl” (where the printed surface becomes concave) occurs in the sheet, then a slight lifting force is applied to the sheet in the upward direction when air is blown in a horizontal direction.

Consequently, if a composition is employed in which a ceiling plate is arranged above the stack of paper sheets having been printed and uniform air blowing is carried out on the stack of paper sheets from a side end, then due to the aforementioned lifting force, some sheets on the upper side of the stack tend to move upward in the vicinity of the ceiling plate and the flow of air becomes worse. Moreover, the attitude of the sheets during air blowing becomes instable and especially in the case of thin sheets, problems of folding and the like can occur readily.

Furthermore, since the state of curl of the sheets changes as seasoning progresses due to the air blowing in the above-described composition, then changes arise in the air blowing conditions required for stabilizing the attitude of the sheets and achieving a uniform air flow.

### SUMMARY OF THE INVENTION

The present invention has been contrived in view of these circumstances, an object thereof being to provide a printing paper seasoning apparatus and method, and an inkjet recording apparatus employing same, whereby seasoning of a stack of paper sheets can be carried out uniformly and rapidly, irrespectively of the state of curl of the paper sheets.

In order to attain the aforementioned object, the present invention is directed to a printing paper seasoning apparatus, comprising: a table on which a plurality of sheets of printing paper are placed in a stack, curl having occurred in the sheets, a direction to which convex sides of the curled sheets face being taken as a curl direction; a ceiling plate which is arranged over the table to face the table and covers an upper side of the stack on the table, a paper accommodating section being defined between the table and the ceiling plate; an air blowing device which has an air blowing port at a lateral side of the paper accommodating section and blows an air flow to the paper accommodating section through the air blowing port; a side plate which is arranged at the lateral side of the paper accommodating section and closes a periphery of the air blowing port of the air blowing device; and an air flow volume difference control device which changes an air flow volume difference in a vertical direction of the air flow blown from the air blowing device during air blowing toward the sheets of printing paper placed in the paper accommodating section, wherein: the air flow volume difference control device varies and controls a relationship between a volume of the air flow supplied to an upper portion of the paper accommodating section and a volume of the air flow supplied to a lower portion of the paper accommodating section; and the air flow volume difference control device controls the air flow volume difference in such a manner that during an initial period of the air blowing, the volume of the air flow supplied to one of the upper portion and the lower portion on a side opposite from the curl direction is greater than the volume of the air flow supplied to the other of the upper portion and the lower portion on a side of the curl direction, and during a latter period of the air blowing, compared with the initial period of the air blowing, the volume of the air flow supplied to the one of the upper portion and the lower portion on the side opposite from the curl direction is reduced and the volume of the air flow supplied to the other of the upper portion and the lower portion on the side of the curl direction is increased.

According to this aspect of the present invention, by employing a composition in which the air flow volume difference in the vertical direction is changed in accordance with the time from the start of air blowing, so as to correspond to the state of curl, it is possible to blow a sufficient air flow between the sheets of printing paper irrespectively of the curl state of the sheets of printing paper, and therefore seasoning can be performed rapidly and uniformly in respect of all of the sheets of printing paper.

More specifically, in the case where the curl direction is a downward direction, the air flow volume difference control device controls the air flow volume difference in such a manner that during the initial period of the air blowing, the volume of the air flow supplied to the upper portion is greater than the volume of the air flow supplied to the lower portion, and during the latter period of the air blowing, compared with the initial period of the air blowing, the volume of the air flow supplied to the upper portion is reduced and the volume of the air flow supplied to the lower portion is increased.

If the state of curl of the paper sheets is a downward curl, then in the initial period of air blowing, the paper sheets are liable to move toward the upper side due to the lifting force produced by the curl, and therefore the air flow volume on the upper portion is made stronger than the lower portion during the initial period of air blowing, so as to promote the supply of air between the paper sheets. Furthermore, in the latter period of air blowing when seasoning has progressed and the curl has eased to some extent, the air flow volume on the upper portion is reduced and the air flow volume on the lower portion is increased, thereby making it possible to achieve uniform seasoning of all of the paper sheets.

Alternatively, in the case where the curl direction is an upward direction, the air flow volume difference control device controls the air flow volume difference in such a manner that during the initial period of the air blowing, the volume of the air flow supplied to the lower portion is greater than the volume of the air flow supplied to the upper portion, and during the latter period of the air blowing, compared with the initial period of the air blowing, the volume of the air flow supplied to the lower portion is reduced and the volume of the air flow supplied to the upper portion is increased.

If the state of curl of the paper is upward curl, then an inverse control mode to that of the case of downward curl is adopted.

Preferably, the air blowing device includes a plurality of air blowers arranged along the vertical direction; and the air flow volume difference control device controls an air blow output of each of the air blowers.

By arranging two or more air blowing devices in the vertical direction and controlling the output of these air blowing device, it is possible to achieve a desired air flow volume difference (air blowing intensity difference).

It is also preferable that the air flow volume difference control device includes an air flow guide member which restricts a flow direction of the air flow blown from the air blowing device; and the air flow volume difference control device changes the air flow volume difference by altering a shape of the air flow guide member with respect to the air flow blown from the air blowing device.

The mode of altering the “shape of the air flow guide member” includes a mode of changing the attitude or the arrangement angle of the air flow guide member in the air flow channel.

By adopting a composition in which the shape of the air flow guide member is changed in accordance with the time from the start of air blowing, it is possible to achieve a desired air flow volume difference (air blowing intensity difference) in the vertical direction, and it is possible to achieve rapid and uniform seasoning, irrespectively of the curl state of the paper sheets.

Preferably, the air flow guide member is rotatably supported; and the air flow volume difference control device changes the air flow volume difference by changing an angle of the air flow guide member with respect to the air flow by turning the air flow guide member.

It is also preferable that the air flow volume difference control device includes a shutter member which opens and closes a portion of the side plate; and the air flow volume difference control device changes the air flow volume difference by altering a closing ratio of the shutter member.

By reducing the sealing properties of the side plate which closes the periphery of the air blowing port of the air blowing device, the air flow blown out from the air blowing device escapes from the opening, and therefore it is possible to reduce the air blowing intensity (air flow volume) as a result. Consequently, by altering the closing ratio of the shutter in accordance with the time from the start of air blowing, it is possible to achieve a desired air flow volume difference (air blowing intensity difference) in the vertical direction, and rapid and uniform seasoning can be performed irrespectively of the curl state of the paper sheets.

It is also possible to combine suitably the above-described modes of the air flow volume difference control device.

Preferably, at least one of an air blowing volume and an air blowing time of the air blowing device is controlled in accordance with attributes of the printing paper.

A paper information acquisition device which acquires information relating to the attributes of the printing paper may employ a mode which automatically acquires information by means of a paper determination sensor or a paper tray selection signal, or the like, or a composition in which the user enters information by operating a prescribed input device (user interface) or the like. In addition, a mode where information is acquired externally through a communication interface, media interface, or the like is possible.

Preferably, at least one of an air blowing volume and an air blowing time of the air blowing device is controlled in accordance with an amount of ink deposited on the sheets of printing paper.

The information about the amount of ink deposited on the printing paper can be calculated and predicted from the image data for printing. The ink amount information acquisition device which acquires information about the amount of deposited ink may employ a mode in which a user enters information by operating a prescribed input device (user interface), or the like, or a composition where information is acquired externally through a communication interface, media interface, or the like.

Preferably, the printing paper seasoning apparatus further comprises: a curl determination device which determines a state of the curl having occurred in the sheets of printing paper, wherein at least one of an air blowing volume and an air blowing time of the air blowing device is controlled in accordance with determination results of the curl determination device.

By controlling the air blowing conditions in accordance with the determination results of the state of curl, it is possible to carry out efficient seasoning.

Preferably, a static pressure of the air flow blown from the air blowing device is at least 500 Pa.

It is more preferable to simultaneously satisfy both of the following conditions: q>0.02 m³/(min·m), where q is the air flow volume passing per sheet of the printing paper and per unit length of the printing paper in the width direction thereof; and P>500 Pa, where P is the static pressure of the air blown from the air blowing device.

By performing air blowing under these conditions, it is possible to overcome the pressure loss between the sheets of paper and to blow air between the sheets of paper.

Preferably, the printing paper seasoning apparatus further comprises at least one shelf plate member with which the sheets of the printing paper are placed dividedly in a plurality of stacks.

When the number of stacked sheets becomes greater, it becomes more difficult for the air flow to pass by the sheets in the lower positions, due to the effects of gravity (the weight of the paper). In order to resolve this problem, it is possible to employ a composition in which, when many sheets of printing paper are accommodated on the table, the sheets of printing paper are dividedly placed in a suitable number of stacks on the shelf plate members. By dividing the paper accommodating section by means of the shelf plate members and thus creating a plurality of decks in the paper accommodating section, the weight of the paper stack divided into respective stages is supported by the respective shelf plate members and the table. By this means, the load of the paper weight is distributed and an air flow can be passed sufficiently through the paper sheets stacked in the lower positions.

In the case of a composition where the paper sheets are dividedly stacked on the shelf plate members, a desirable mode is one where a plurality of air blowing units (air blowing devices) are arranged respectively for the paper accommodating sections of the decks.

The above-described seasoning apparatus may be constituted as a separate apparatus to a printing apparatus, or may be combined with the printing apparatus and incorporated as a portion of a printing system.

In order to attain the aforementioned object, the present invention is also directed to an inkjet recording apparatus, comprising a paper output section which includes the above-described printing paper seasoning apparatus.

Printed matters produced by the inkjet method have a high water content compared with printed matters produced by other printing methods, and problems due to deformation of the paper are conspicuous, and therefore it is beneficial to carry out seasoning by using the seasoning apparatus according to the present invention in respect of printed matters printed by an inkjet recording apparatus.

In order to attain the aforementioned object, the present invention is also directed to a method of seasoning printing paper in a printing paper seasoning apparatus which comprises: a table on which a plurality of sheets of printing paper are placed in a stack; a ceiling plate which is arranged over the table to face the table and covers an upper side of the stack on the table, a paper accommodating section being defined between the table and the ceiling plate; an air blowing device which has an air blowing port at a lateral side of the paper accommodating section and blows an air flow to the paper accommodating section through the air blowing port; a side plate which is arranged at the lateral side of the paper accommodating section and closes a periphery of the air blowing port of the air blowing device; and an air flow volume difference control device which changes an air flow volume difference in a vertical direction of the air flow blown from the air blowing device during air blowing toward the sheets of printing paper placed in the paper accommodating section and which varies and controls a relationship between a volume of the air flow supplied to an upper portion of the paper accommodating section and a volume of the air flow supplied to a lower portion of the paper accommodating section, the method comprising the steps of: placing a plurality of sheets of printing paper in the paper accommodating section, curl having occurred in the sheets, a direction to which convex sides of the curled sheets face being taken as a curl direction; and performing air blowing toward the sheets of printing paper placed in the paper accommodating section by the air blowing device while controlling the air flow volume difference by the air flow volume difference control device in such a manner that during an initial period of the air blowing, the volume of the air flow supplied to one of the upper portion and the lower portion on a side opposite from the curl direction is greater than the volume of the air flow supplied to the other of the upper portion and the lower portion on a side of the curl direction, and during a latter period of the air blowing, compared with the initial period of the air blowing, the volume of the air flow supplied to the one of the upper portion and the lower portion on the side opposite from the curl direction is reduced and the volume of the air flow supplied to the other of the upper portion and the lower portion on the side of the curl direction is increased.

More specifically, in the case where the curl direction is a downward direction, in the step of performing the air blowing, the air flow volume difference is controlled in such a manner that during the initial period of the air blowing, the volume of the air flow supplied to the upper portion is greater than the volume of the air flow supplied to the lower portion, and during the latter period of the air blowing, compared with the initial period of the air blowing, the volume of the air flow supplied to the upper portion is reduced and the volume of the air flow supplied to the lower portion is increased.

Alternatively, in the case where the curl direction is an upward direction, in the step of performing the air blowing, the air flow volume difference is controlled in such a manner that during the initial period of the air blowing, the volume of the air flow supplied to the lower portion is greater than the volume of the air flow supplied to the upper portion, and during the latter period of the air blowing, compared with the initial period of the air blowing, the volume of the air flow supplied to the lower portion is reduced and the volume of the air flow supplied to the upper portion is increased.

Preferably, in the step of performing the air blowing, at least one of an air blowing volume and an air blowing time of the air blowing device is controlled in accordance with attributes of the printing paper.

It is also preferable that in the step of performing the air blowing, at least one of an air blowing volume and an air blowing time of the air blowing device is controlled in accordance with an amount of ink deposited on the sheets of printing paper.

It is also preferable that the method further comprises the step of: determining a state of the curl having occurred in the sheets of printing paper, wherein in the step of performing the air blowing, at least one of an air blowing volume and an air blowing time of the air blowing device is controlled in accordance with determination results obtained in the step of determining the state of the curl.

According to the present invention, it is possible to rapidly and uniformly perform seasoning of a stack of paper sheets irrespectively of the state of curl of the paper sheets. Thereby, it is possible to prevent expansion/contraction and deformation of the paper after printing, and it is also possible to improve productivity of the printed matters. Furthermore, according to the present invention, it is possible to prevent displacement in register on front and rear surfaces when carrying out double-side printing, and suitability for subsequent processes, such as a binding process, is also improved.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a perspective diagram of a seasoning apparatus according to a first embodiment of the present invention;

FIG. 2 is a perspective diagram showing a state where a stack of paper sheets has been placed on a table of the seasoning apparatus;

FIG. 3 is a plan diagram showing a schematic view of the flow of air inside the seasoning apparatus;

FIGS. 4A to 4C are side view diagrams showing schematic views of a state during air blowing;

FIG. 5 is a timing chart showing an embodiment of control of the air flow volume of the upper-stage and lower-stage blowers;

FIG. 6 is a block diagram showing the composition of a control system of the seasoning apparatus;

FIG. 7 is a principal part schematic drawing of a seasoning apparatus according to a second embodiment of the present invention;

FIG. 8 is a timing chart showing an embodiment of control of an air flow guide angle;

FIG. 9 is a principal part schematic drawing of a seasoning apparatus according to a third embodiment of the present invention;

FIGS. 10A to 10C are explanatory diagrams of the operation of a shutter, showing a side plate in FIG. 9 as viewed from above;

FIG. 11 is a timing chart showing an embodiment of the control of opening and closing the shutter;

FIG. 12 is a block diagram showing a seasoning apparatus according to a fourth embodiment of the present invention;

FIG. 13 is a principal part schematic drawing showing a seasoning apparatus according to a fifth embodiment of the present invention;

FIG. 14 is an illustrative diagram of a printed matter used for evaluating air flow volume conditions;

FIGS. 15A and 15B are illustrative diagrams for describing a method of evaluating air flow volume conditions;

FIG. 16 is a graph showing the correlation between the air flow volume and seasoning time;

FIG. 17 is a graph showing the correlation between the air flow volume and pressure loss; and

FIG. 18 is a schematic drawing of an inkjet recording apparatus according to an embodiment of the present invention.

### DESCRIPTION OF THE PREFERRED EMBODIMENTS

### First Embodiment

### <Composition of Seasoning Apparatus>

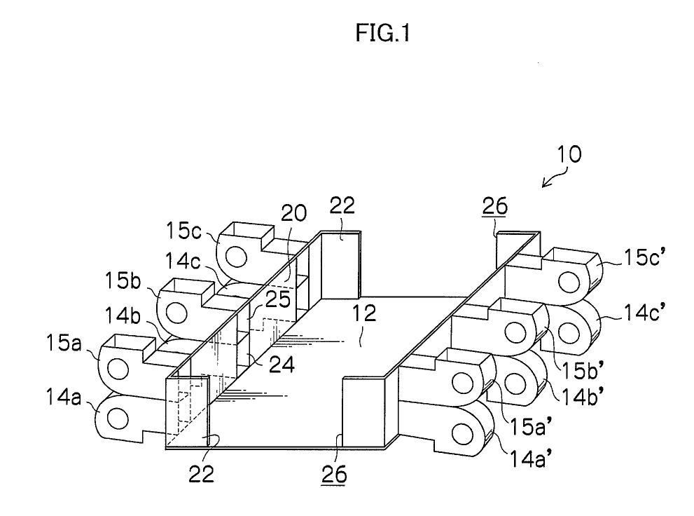

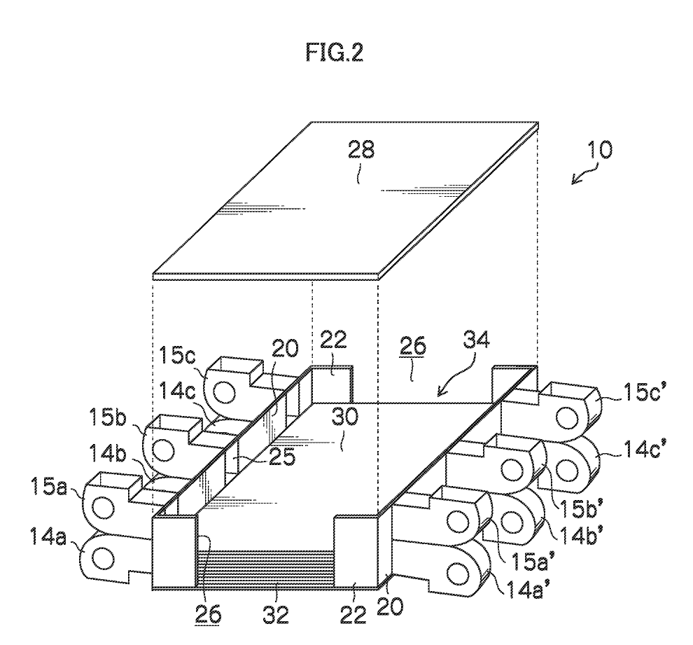

FIG. 1 is a perspective diagram of a seasoning apparatus according to a first embodiment of the present invention. As shown in FIG. 1, the seasoning apparatus 10 includes: a table 12, on which a plurality of sheets of printing paper 30 (not shown in FIG. 1, and shown in FIG. 2; hereinafter also referred to simply as “paper”) can be stacked; and blowers 14a, 14b, 14c, 14a′, 14b′, 14c′, 15a, 15b, 15c, 15a′, 15b′ and 15c′, which blow air over the outer perimeter faces of the paper stack placed on the table 12.

In order to simplify the description below, the lower-stage blowers 14a to 14c and 14a′ to 14c′ may be referred to as the blowers 14, and the upper-stage blowers 15a to 15c and 15a′ to 15c′ may be referred to as the blowers 15. The blowers 14 and 15 in FIG. 1 are depicted as axial flow blowers; however, there are no particular restrictions on the air blowing method, and it is also possible to use centrifugal blowers.

The seasoning apparatus 10 in the present embodiment has a composition in which air is blown toward the paper stack over the end faces of two sides corresponding to the long sides of rectangular cut sheets, and the blowers 14 and 15 are arranged in two stages, the upper and lower stages, to face the long sides of the paper stack. In the lower part of the left-hand side in FIG. 1, the lower-stage blowers 14a, 14b and 14c are arranged at equidistant intervals in the lengthwise direction of the paper, and the upper-stage blowers 15a, 15b and 15c are similarly arranged at equidistant intervals, near to and above the lower-stage blowers 14a, 14b and 14c.

The blower arrangement on the right-hand side in FIG. 1 adopts a similar configuration, in such a manner that the blowers 14a and 14a′ have blowing outlets (air blowing ports) which oppose each other across the paper stack (not shown in FIG. 1) on the table 12, and the blowers 14b and 14b′, 14c and 14c′, 15a and 15a′, 15b and 15b′, and 15c and 15c′ similarly have blowing outlets respectively opposing each other across the paper stack on the table 12.

By thus arranging the blowers 14 and 15 in the upper and lower stages, it is possible to create an air flow with a cross-sectional area capable of supplying air to all of the stacked sheets simultaneously, as well as being able to control the difference of the air flow volume in the stacking direction of the sheets of paper 30 (i.e., in the vertical direction). Moreover, by arranging the plurality of blowers 14a to 14c and 15a to 15c at equidistant intervals in the lengthwise direction of the paper sheets (i.e., in the horizontal direction), it is possible to optimize the difference of the air flow volume in the lengthwise direction of the paper sheets. Furthermore, by blowing air simultaneously toward both side faces of the paper stack (i.e., from the two opposite directions) by arranging the blowing ports to mutually oppose, it is possible to supply air efficiently in between the paper sheets.

The seasoning apparatus 10 further includes side plates 20 and 22 erected at the four outer perimeter faces of the table 12, in order to restrict the position of paper stack on the table 12 and also to improve the efficiency of the air flow. Openings or slits serving as air blowing ports 24 and 25 are formed respectively in the side plates 20 on the faces where the blowers 14 and 15 are arranged, at the positions of the air blowing ports of the blowers 14 and 15.

Each of the air blowing ports 24 and 25 has an opening length substantially equal to the height of a paper accommodating section defined by the table 12 and a ceiling plate 28 (not shown in FIG. 1, and shown in FIG. 2) in the paper stacking direction, in such a manner that an air flow is blown simultaneously throughout substantially the whole of the paper accommodating section in the height direction. By adopting this composition, it is possible to apply the air flow simultaneously to all of the paper sheets stacked on the table 12.

By adopting a composition which thereby restricts the range of the air blowing outlets and closes off the perimeters of the air blowing ports 24 and 25 with the wall members (side plates 20), the direction of travel of the air flow blowing from the blowers 14 and 15 is restricted and leaking of air is prevented. Thus, it is possible to introduce the air flow generated by the blowers 14 and 15 efficiently into a paper accommodating section 34 on the table 12, and a strong air flow can be directed onto the paper stack placed on the table 12.

On the other hand, air passage ports 26 which allow the air flow to escape (hereinafter referred to as “air escape ports”) are formed in the side plates 22 which are erected on the sides where the blowers 14 and 15 are not arranged (in the present embodiment, the sides corresponding to the shorter sides of the paper sheets) of the outer perimeter faces of the table 12. In the present embodiment, a rectangular opening (cutaway section) of uniform width is formed in the central portion of each side plate 22 as the air escape hole 26. It is possible to efficiently introduce the air flow by restricting the air blowing ports 24 and 25, which introduce air into the paper accommodating section 34, and the air escape ports 26, from which the air exits.

The number and specifications of the blowers 14 and 15 constituting the air blowing device, and the size and shape of the air blowing ports 24 and 25, and the like, are designed appropriately by taking account of the size, material, thickness, quantity, etc., of the paper sheets, so as to obtain the air flow volume and pressure required in order to satisfy the prescribed air blowing conditions. Furthermore, the height dimension of the side plates 20 and 22 is designed appropriately in accordance with the maximum height of the paper stack that can be set on the table 12.

FIG. 2 is a perspective diagram showing a state where a stack 32 of paper 30 has been placed on the table 12. As shown in FIG. 2, the stack 32 of paper 30 after printing is placed on the table 12, and is covered from above with the ceiling plate 28. The ceiling plate 28 is arranged substantially in parallel with the face of the table 12, and prevents the paper 30 from flying upward during air blowing. The ceiling plate 28 may be fixed at a prescribed height position, for instance, so as to contact the upper end faces of the side plates 20 and 22 and thereby close off the ceiling face of the paper accommodating section 34, or may adopt a composition whereby the height position of the ceiling plate 28 can be adjusted appropriately in accordance with the number of sheets of paper 30 to be processed.

For instance, the ceiling plate 28 is arranged movably in the stacking direction of the paper 30, by means of a position adjusting device including a movement mechanism 54 (not shown in FIG. 2, and shown in FIG. 6). Consequently, the height position of the ceiling plate 28 is adjusted in accordance with the number of sheets of paper 30 disposed on the table 12, thereby forming the paper accommodating section 34 having a suitable height corresponding to the number of sheets to be processed.

Moreover, the ceiling plate 28 may be composed so as to be raisable at the start of air blowing. By starting the blowing of air from the blowers 14 and 15, air is supplied between the sheets of paper 30 on the table 12, thereby forming suitable gaps between the sheets of paper 30, and therefore the height position of each sheet of paper rises with the air blowing action. Consequently, the height position of the uppermost sheet of paper also rises up compared to when no air is being blown. Hence, a desirable composition is one where the ceiling plate 28 is raised up in accordance with the amount of floating up of the sheets of paper 30 during the blowing of air. By adopting this composition, it is possible to ensure a suitable gap between the sheets of paper 30, as well as being able to suppress flapping of the sheets of paper 30 due to the air blowing, and damage to the printed matter as a result of contact between the paper 30 and the ceiling plate 28 can be avoided.

### <Mode of Air Blowing Device>

Since the chief aim of the seasoning apparatus 10 according to the present embodiment is to uniformize the water content in the paper (adjust to the ambient temperature and humidity) after ink has been deposited on at least one side of the paper, it is desirable that the air blowing devices blow the peripheral air (i.e., a flow of air having the temperature and humidity of the surrounding environment), from the viewpoint of preventing excessive drying.

Supposing that a device is employed which blows an air flow of low humidity, such as air heated by a heater or the like (warm air flow), compressed air, dry air, or the like, then the remaining amount of water contained in the paper becomes lower than the ambient saturation point, and shrinkage of the paper occurs. For example, if a low-humidity air flow is used, then although it is possible to carry out drying in a short period of time in regions where a large amount of ink has been deposited onto the paper, an excessively dried state occurs in areas of the paper where no ink has been deposited or regions where the amount of deposited ink is extremely small. There is a possibility that the resulting difference in the amount of water may produce expansion and contraction (i.e., deformation) of the paper.

In this respect, the air blowing devices in the present embodiment are composed so as to blow air having the temperature and humidity of the surrounding environment by means of the air blowers 14 and 15 (see FIGS. 1 and 2), and are not provided with any device for controlling and adjusting the temperature and humidity, such as a heating device or a dehumidifying device. By adopting this composition, it is possible to adjust the paper after printing to the ambient temperature and humidity, and it is also possible to suppress deformation caused by expansion and contraction of the paper.

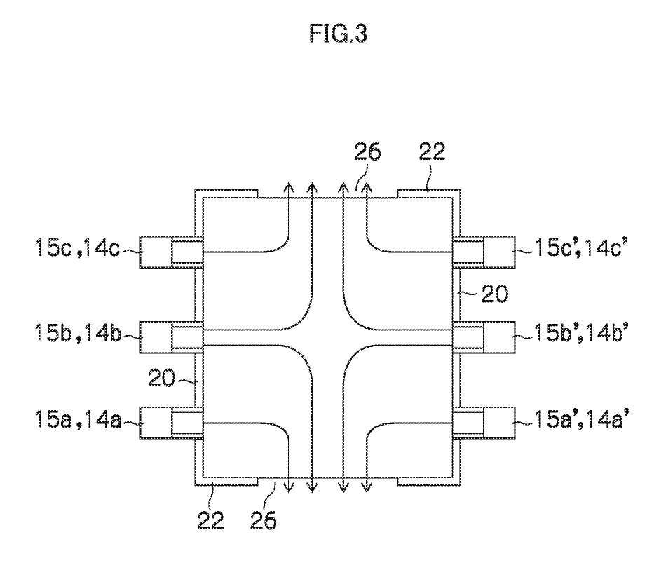

FIG. 3 is a plan diagram showing a schematic view of a state during air blowing, in which the arrows indicate the approximate paths of the air flow. As shown in FIG. 3, a composition is adopted in which air is forcibly blown by the mutually opposed blowers, and the air flow exits from the air escape ports 26, thereby maintaining a stable attitude of the paper sheets of while supplying sufficient air between the paper sheets.

In order to achieve a stable air flow with good symmetry from two mutually opposing directions on either side of the sheets of paper 30, the driving of the blowers is controlled in such a manner that each pair of blowers which have mutually opposing blowing outlets on either side of the sheets of paper 30 (14a and 14a′, 14b and 14b′, . . . ) respectively output the same air flow volume.

It is possible to adopt a mode in which the air flow volume is made equal between the blowers which are arranged in the lengthwise direction of the paper (for example, the blowers 14a, 14b and 14c), or a mode where their air flow volumes are different. For example, the balance of the air flow volume can be controlled within the row of blowers so as to create a desired difference of the air flow volume in the horizontal direction: for instance, the air flow volume of the central blower 14b can be made larger than the air flow volume of the end blowers 14a and 14c.

The magnitude of the air flow volume corresponds to the intensity of the blown air flow, and hence a difference of the air flow volume can be interpreted as a difference of the intensity of the blown air flow.

### <Embodiment of Control of Air Flow Volume Difference in Vertical Direction>

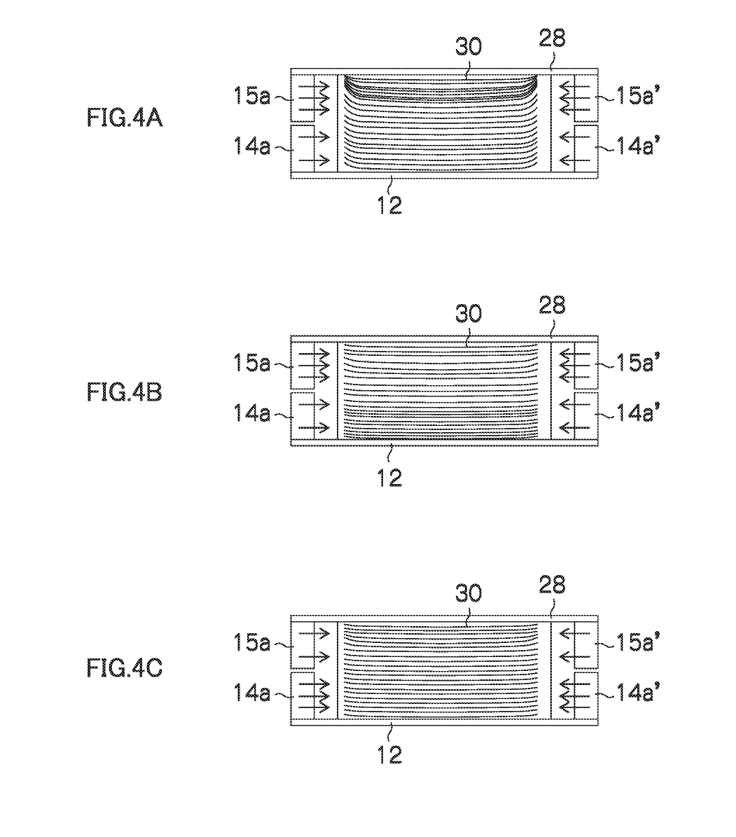

FIGS. 4A to 4C are side view diagrams showing schematic drawings of a state during air blowing, and depict the passage of time after the start of air blowing in the sequence of FIG. 4A→FIG. 4B→FIG. 4C. For the sake of convenience of the drawings, two pairs of the blowers (14a and 14a′, and 15a and 15a′) are depicted in simplified form. Similar air flow volume control is applied to the other pairs of blowers.

FIG. 4A shows a state immediately after the start of air blowing in the initial period of the air blowing. In the present embodiment, the sheets of paper 30 after printing on one surface thereof are stacked on the table 12 with the recording surface (printed surface) facing upward. In this case, curl that causes the recording surface to become concave occurs in the sheets of paper 30. Here, the “curl direction” of the paper sheet is defined as the direction in which the convex surface is facing, then in the case in FIG. 4A, the convex surface of the paper 30 is facing downward and therefore the curl direction is the downward direction.

When an air flow is blown from both the left-hand side and the right-hand side from the blower pairs 14a and 14a′, and 15a and 15a′ toward the sheets of paper 30 having this curl state (inverse curl), air is supplied between the sheets of paper 30. In this case, due to the lifting force produced by the paper curl, the sheets of paper 30 are liable to move toward the ceiling plate 28 and collect in the vicinity of the ceiling plate 28 (the upper portion of the paper accommodating section 34). Therefore, a situation occurs in which it is difficult to introduce an air flow between the sheets of paper 30 in this upper portion.

In order to improve this situation, in the initial stage of air blowing where the amount of curl is large, the air flow volume of the upper-stage blowers is made larger than the air flow volume in the lower-stage (see FIGS. 4A and 4B). Consequently, the air flow can enter readily in between the sheets of paper 30 on the upper side.

On the other hand, in respect of the sheets of paper 30 on the lower side of the paper stack, due to the effects of the weight of the paper sheets and the downward pressure created by the air flow on the upper side, a situation arises where the air flow is not liable to enter in between the paper sheets on the lower side.

When the air blowing with the air flow volume difference shown in FIGS. 4A and 4B has continued for a prescribed period of time and seasoning has progressed to a certain extent, then the curl in the sheets of paper 30 begins to diminish (FIG. 4B). Due to the reduction in the amount of curl as the seasoning progresses, the lifting force also reduces. Therefore, in the latter period of the air blowing in which the amount of curl has reduced to a certain extent, the air flow volume of the upper-stage blowers is decreased and the air flow volume of the lower-stage blowers is increased (FIG. 4C). This enables to pass a sufficient air flow through all the sheets of paper 30 to uniformly season the sheets of paper 30.

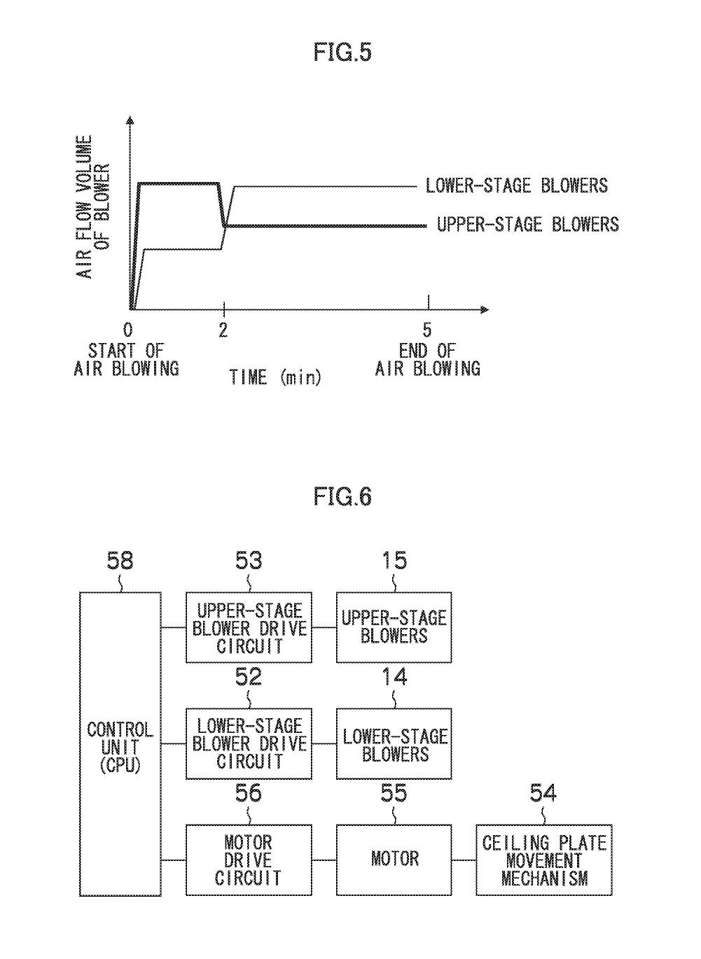

FIG. 5 is a timing chart showing an embodiment of the control of the air flow volumes in the upper-stage and lower-stage blowers described with reference to FIGS. 4A to 4C. The horizontal axis represents time (unit: minute) and the vertical axis represents the air flow volume of the blower (here, relative values are shown). In FIG. 5, the time period from the start of air blowing to the end of air blowing (the seasoning time) is taken to be 5 minutes. The period before approximately 2 minutes from the start of air blowing can be regarded as the “initial period of air blowing”, and the period after this time can be regarded as the “latter period of air blowing”.

In FIG. 5, the air flow volume of the lower-stage blowers is depicted with the thin line and the air flow volume of the upper-stage blowers is depicted with the thick line. As shown in FIG. 5, the blowers 14 and 15 are controlled in such a manner that the air flow volume of the upper-stage blowers is greater than the air flow volume of the lower-stage blowers during the initial period of air blowing, whereupon, during the latter period of air blowing, the air flow volume of the lower-stage blowers is greater than the air flow volume of the upper-stage blowers.

Thus, the difference of the air flow volume adapted to the state of curl is achieved, and uniform seasoning can be carried out in respect of the sheets of paper. Furthermore, the attitude of the sheets of paper during the air blowing is stabilized and the occurrence of folding and bending, and the like, can be prevented.

FIG. 6 is a block diagram showing a composition of a control system of the seasoning apparatus 10 according to the present embodiment. As shown in FIG. 6, the seasoning apparatus 10 according to the present embodiment includes a drive circuit 52 for driving the lower-stage blowers 14, a drive circuit 53 for driving the upper-stage blowers 15, a motor 55 for driving the movement mechanism 54 of the ceiling plate 28, a drive circuit 56 for the motor 55, and a control unit 58 which controls the drive circuits 52, 53 and 56.

The control unit 58 is constituted of a central processing unit (CPU) and peripheral circuits thereof, for example, and supplies control signals to the drive circuits 52, 53 and 56 in accordance with a prescribed program, thereby controlling the operation of the blowers 14 and 15 and the motor 55. The control unit 58 serves the role of an “air flow volume difference control device” in terms of varying and controlling the difference of the air flow volume in the vertical direction by controlling the output air blowing volume (air blowing intensity) of the lower-stage blowers 14 and the upper-stage blowers 15.

According to the seasoning apparatus 10 having the composition described above, it is possible to pass a sufficient air flow over all of the surfaces of the paper sheets, regardless of the state of curl of the paper sheets, and seasoning of the paper stack can be carried out uniformly and rapidly.

### <Modification Example: When the Curl Direction is Upward>

In FIGS. 4A to 4C, the paper sheets having the downward curl are depicted for example. Alternatively, in the case of paper sheets having the upward curl, the paper sheets receive a force in the downward direction due to the air flow blown from the side faces. Therefore, conversely to the example in FIGS. 4A to 4C, the paper sheets are liable to move toward the table 12 and a situation occurs in which it is difficult to introduce an air flow between the paper sheets on the lower side.

Hence, in the case of paper sheets having the upward curl, the air flow volume of the lower-stage blowers is made larger than the upper-stage blowers during the initial period of air blowing. As the curl diminishes, the air flow volume of the lower-stage blowers is reduced and the air flow volume of the upper-stage blowers is increased in the latter period of air blowing.

By controlling the balance of air flow volumes in this way, it is possible to pass a sufficient air flow over all of the surfaces of the paper sheets, and hence the paper stack can be seasoned uniformly and rapidly.

The reversal of the difference of the air flow volume in the vertical direction in accordance with the reversal in the curl direction is as described in this modification example. Although the second to fourth embodiments explained below are described with respect to only a case of downward curl as shown in FIGS. 4A to 4C for example, the reversal can be made as described above also in the second to fourth embodiments.

### Second Embodiment

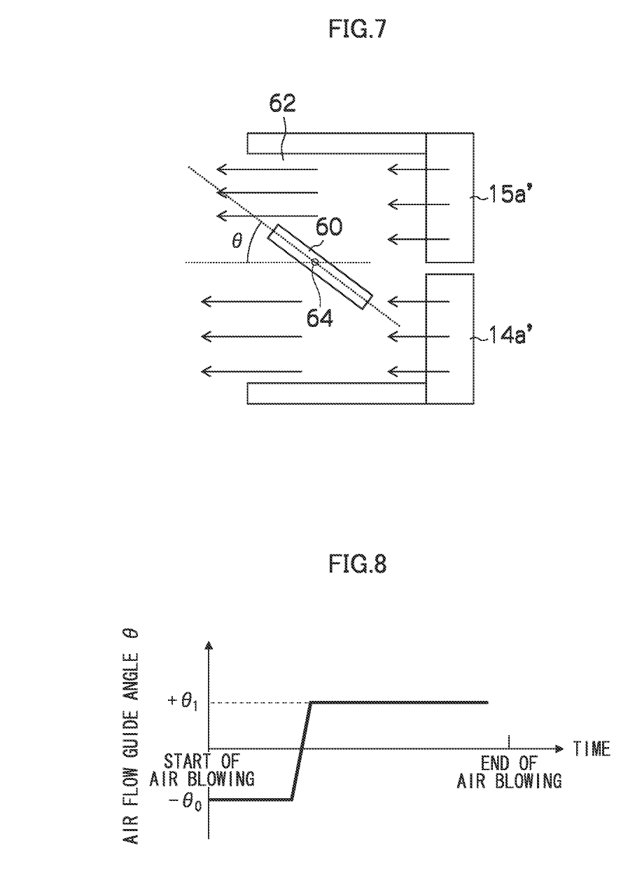

FIG. 7 is a principal part schematic drawing of a seasoning apparatus according to a second embodiment of the present invention. In FIG. 7, elements which are the same as or similar to those in the composition described in FIGS. 1 to 4C are denoted with the same reference numerals, and description thereof is omitted here. In the first embodiment described with reference to FIGS. 1 to 6, the device for varying and controlling the difference of the air flow volume in the vertical direction controls the output of each of the upper-stage blowers 15 and the lower-stage blowers 14. It is also possible to use, either instead of such the device or in combination with same, an air flow guide member 60 as shown in FIG. 7. Here, only the portion corresponding to the blowers 14a′ and 15a′ is depicted, and similar air flow guide members 60 are respectively arranged for the other blower units (14a and 15a, 14b and 15b, 14c and 15c, 14b′ and 15b′, and 14c′ and 15c′).

The air flow guide member 60 is arranged in the vicinity of the blowing outlets of the upper and lower blowers 14a′ and 15a′ in substantially the central portion of an air flow channel 62 thereof. The air flow guide member 60 is a substantially flat plate-shaped member, which has the length in the direction perpendicular to the plane of the drawing and is rotatably supported on a rotational axis 64 along the direction perpendicular to the plane of the drawing with a supporting mechanism (not shown). The air flow guide member 60 restricts the direction of flow of the air blown from the blowers 14a′ and 15a′, and it is possible to change the difference of the air flow volume in the vertical direction by changing the angle of the air flow guide member 60.

In FIG. 7, the angle formed between the air flow guide member 60 and the horizontal plane parallel to the surface of the table 12 is defined as the “air flow guide angle θ”; a positive angle indicates the counter-clockwise direction from the horizontal plane and a negative angle indicates the clockwise direction. In the case shown in FIG. 7, the air flow guide angle θ has a negative value. As shown in FIG. 7, when the angle θ<0, the air flow volume on the upper side is greater (and the air blowing intensity is stronger) than the air flow volume on the lower side. Conversely, when the angle θ>0, the air flow volume on the lower side is greater (and the air blowing intensity is stronger) than the air flow volume on the upper side.

FIG. 8 is a timing chart showing an embodiment of the control of the air flow guide angle described with reference to FIG. 7. The horizontal axis indicates time (unit: minutes) and the vertical axis represents the air flow guide angle θ. When the curl direction is downward, then as shown in FIG. 8, the angle of the air flow guide member 60 in the initial period of air blowing is set to a prescribed negative value −θ₀, thereby making the air flow volume on the upper side greater (and the air blowing intensity stronger) than the air flow volume on the lower side. Thereafter, in the latter period of air blowing, the angle of the air flow guide member 60 is set to a prescribed positive value θ₁, thereby making the air flow volume on the lower side greater than the air flow volume on the upper side. The absolute values of the negative value −θ₀ and the positive value θ₁ may be either the same value or different values.

By thus altering the air flow guide angle θ, the attitude of the air flow guide member 60 inside the air flow channel 62 is changed, and the difference of the air flow volume (the difference of the air blowing intensity) in the vertical direction changes. According to this mode, it is possible to control the difference of the air flow volume simply by altering the angle of the air flow guide member 60, without varying and controlling the outputs of the blowers 14 and 15.

It is also possible to change the difference of the air flow volume by means of a mode in which the shape of the actual air flow guide member is changed to a different shape (for example, the length is extended or reduced, the width is expanded or contracted, a partially deformed shape is adopted, or the like), either instead of or in combination with the device that changes the difference of the air flow volume by altering the attitude (angle) of the air flow guide member 60 in the air flow channel 62.

### Third Embodiment

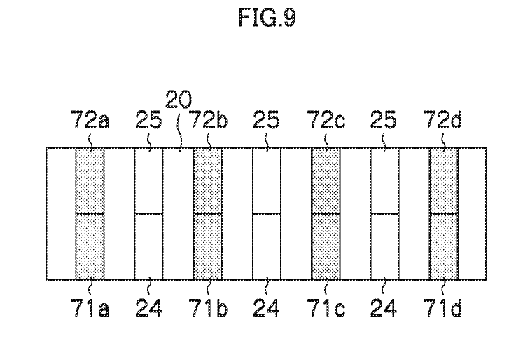

FIG. 9 is a principal part schematic drawing of a seasoning apparatus according to a third embodiment of the present invention. FIG. 9 shows an embodiment which is provided with shutters 71a, 71b, 72c, 71d, 72a, 72b, 72c and 72d as devices for altering the closing ratio of the side plates 20. The same structure is employed in the side plates 20 which are arranged in opposing positions on the sides of the sheets of paper 30 shown in FIG. 1.

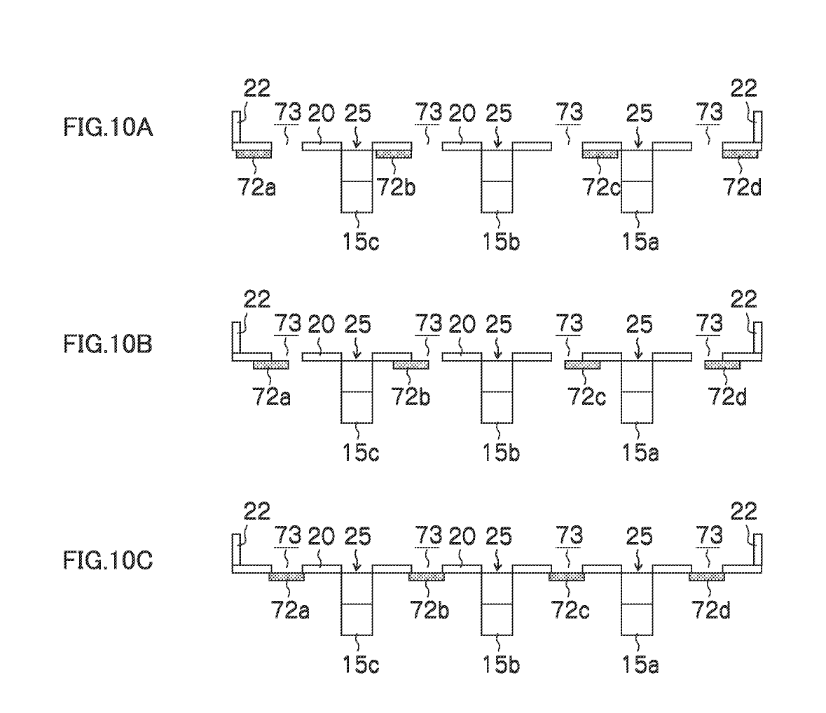

FIGS. 10A to 10C are diagrams showing the side plate 20 shown in FIG. 9 as viewed from above. In FIGS. 10A to 10C, only the upper-stage shutters 72a to 72d are depicted, but the lower-stage shutters 71a to 71d (see FIG. 9) have a similar composition. Opening sections 73 (see FIGS. 10A to 10C) are formed in the side plates 20 at positions corresponding to the shutters 71a to 71d and 72a to 72d.

FIG. 10A shows a state where the shutters 72a to 72d fully open (the closing ratio of the opening sections 73 corresponding to the shutters 72a to 72d is 0%); FIG. 10B shows a state where the shutters 72a to 72d half open (the closing ratio of the opening sections 73 corresponding to the shutters 72a to 72d is 50%), and FIG. 10C shows a state where the shutters 72a to 72d fully close (the closing ratio of the opening sections corresponding to the shutters 72a to 72d is 100%).

When the shutters 72a to 72d open and the periphery of the air blowing ports 25 is thereby opened (i.e., when reducing the closing ratio of the side plate 20), the air flow escapes to the exterior through the openings (opening sections 73), and the blown air flow volume correspondingly reduces (the air blowing intensity correspondingly reduces). Thus, it is possible to change the blown air flow volume (air blowing intensity) by changing the closing ratio of the opening sections 73 by means of the shutters 72a to 72d.

The shutters 72a to 72d can change the closing ratio continuously or stepwise. When changing the air flow volume on the upper side, the upper-stage shutters 72a to 72d are controlled to open and close, and when changing the air flow volume on the lower side, the lower-stage shutters 71a to 71d are controlled to open and close.

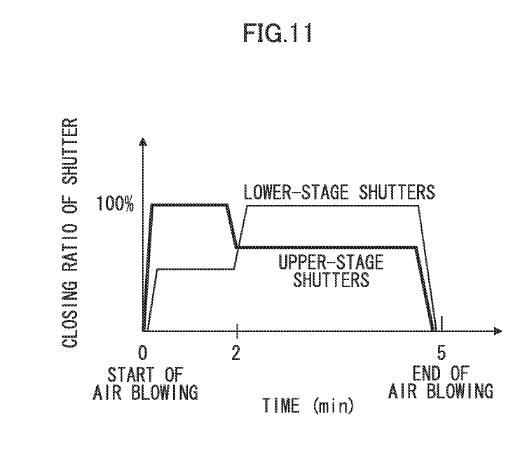

FIG. 11 is a timing chart showing an embodiment of the control of opening and closing of the shutters. In the case of paper sheets having downward curl, as shown in FIG. 11, the closing ratio of the upper-stage shutters is set to 100% (fully closed) during the initial period of air blowing, whereas the closing ratio of the lower-stage shutters is lowered (to approximately 40% in the embodiment shown in FIG. 11). Consequently, the air flow volume (air blowing intensity) on the upper side is greater than on the lower side. Thereafter, in the latter period of air blowing, the closing ratio of the lower-stage shutters is set to 100%, thereby increasing the air flow volume on the lower side, and the closing ratio of the upper-stage shutters is lowered (to approximately 60% in the embodiment shown in FIG. 11), thereby decreasing the air flow volume on the upper side.

It is desirable that the closing ratio is decreased just before the end of air blowing, in order to remove air from between the paper sheets so as to improve the stationary positioning of the paper sheets, and it is more desirable that all of the shutters in both the upper stage and the lower stage are set fully open just before the end of air blowing, as shown in FIG. 11.

In the third embodiment, the shutters are operated simultaneously in the units of shutters in each of the upper and lower stages, thereby uniformly varying and controlling the closing ratio in each stage by taking account of achieving uniform balance of the air flow volume in the horizontal direction in each stage; however, it is also possible to adopt a mode in which the closing ratios of the opening sections are changed and controlled independently in the respective shutters 71a to 72d.

### Fourth Embodiment

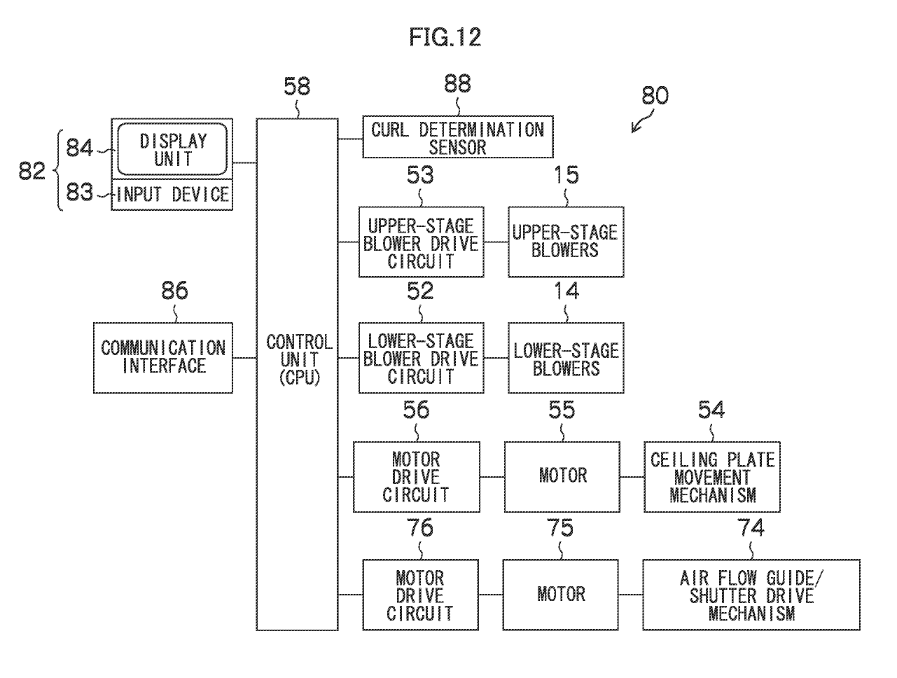

FIG. 12 is a block diagram showing a composition of a control system of a seasoning apparatus according to a fourth embodiment of the present invention.

In FIG. 12, elements which are the same as or similar to those in the composition described in FIG. 6 are denoted with the same reference numerals, and description thereof is omitted here.

The seasoning apparatus 80 according to the fourth embodiment shown in FIG. 12 is provided with an operating unit 82 as a user interface. The operating unit 82 includes an input device 83 whereby an operator (user) can perform various inputs, and a display unit (display monitor) 84. The input device 83 can use various modes, such as a keyboard, a mouse, a touch panel, buttons, and the like. By operating the input device 83, the user is able to enter printing conditions (paper type, paper name, and other attribute information of paper, printing mode, etc.), as well as entering, editing, searching, and otherwise processing, additional information. The various information such as the input contents and search results, and the like, can be confirmed through the display on the display unit 84.

The seasoning apparatus 80 further includes a communication interface 86, and can obtain information through the communication interface 86 directly from an external apparatus (not shown) such as a control circuit, a host computer, or the like, of the printing apparatus. The communication system of the communication interface 86 is not limited in particular, and may be a wired or wireless system. The devices for acquiring information from an external source may include a media interface that reads and writes from and to an external storage medium (removable medium), either instead of or in addition to the input device 83 and the communication interface 86. By means of these devices, the seasoning apparatus 80 can acquire information about the attribute information of the paper (paper type, name, and the like), and the amount of ink deposited on the printing paper. The amount of ink deposited on the paper can be calculated from the image data that is the object of printing.

The seasoning apparatus 80 further includes a curl determination sensor 88, which determines the state of curl (the direction and amount of curl) of the sheets of paper 30. It is possible to use an optical sensor for the curl determination sensor 88. The curl determination sensor 88 determines the state of curl of the paper sheets before the start of seasoning (before air blowing) or during the seasoning process (during air blowing, or when air blowing has been halted temporarily), and supplies the corresponding determination signals to the control unit 58.

The seasoning apparatus 80 shown in FIG. 12 further includes: a drive mechanism 74 that is required to drive the conveyance guide 60 and/or the shutters 71a to 71d and 72a to 72d, which are described in the second embodiment with reference to FIGS. 7 and 8 and in the third embodiment with reference to FIGS. 9 to 11; a motor 75 that serves as the drive source for the drive mechanism 74; and a drive circuit 76 of the motor 75.

According to the seasoning apparatus 80 shown in FIG. 12, it is possible to appropriately control the air flow volume and the air blowing time in accordance with the attributes of the sheets of paper 30, such as the paper type and paper name, the sheet size, and so on. For example, the optimal seasoning time and the timing at which the vertical air flow volume difference is switched, as well as the balance of air flow volumes, and the like, corresponding to the attributes of the sheets of paper used are decided in advance by experimentation, or the like, and the related information is stored in a storage device, such as a ROM, in the form of a data table. The control unit 58 controls the air blowing in accordance with the relevant conditions, by referring to this data table.

According to the seasoning apparatus 80, it is also possible to appropriately control the air flow volume and the air blowing time in accordance with the amount of ink deposited on the sheets of paper 30. Similarly to the foregoing, the optimal seasoning time and the timing at which the vertical air flow volume difference is switched, as well as the balance of air flow volumes, and the like, corresponding to the amount of deposited ink are decided in advance by experimentation, or the like, and the related information is stored in the storage device, such as the ROM, in the form of a data table. The control unit 58 controls the air blowing in accordance with the relevant conditions, by referring to this data table. Generally, the greater the amount of deposited ink is, the longer the air blowing time is.

Furthermore, according to the present seasoning apparatus 80, the control unit 58 appropriately controls the air flow volume and the air blowing time in accordance with the determination results obtained from the curl determination sensor 88. Similarly to the foregoing, the optimal seasoning time and the timing at which the vertical air flow volume difference is switched, as well as the balance of air flow volumes, and the like, corresponding to the amount of curl and the direction of curl are decided in advance by experimentation, or the like, and the related information is stored in the storage device, such as a ROM, in the form of a data table. The control unit 58 controls the air blowing in accordance with the relevant conditions, by referring to this data table.

It is also possible to adopt a mode in which the air blowing is controlled by suitably combining the respective factors described above, namely, the paper attributes, the amount of deposited ink and the curl determination results.

### Fifth Embodiment

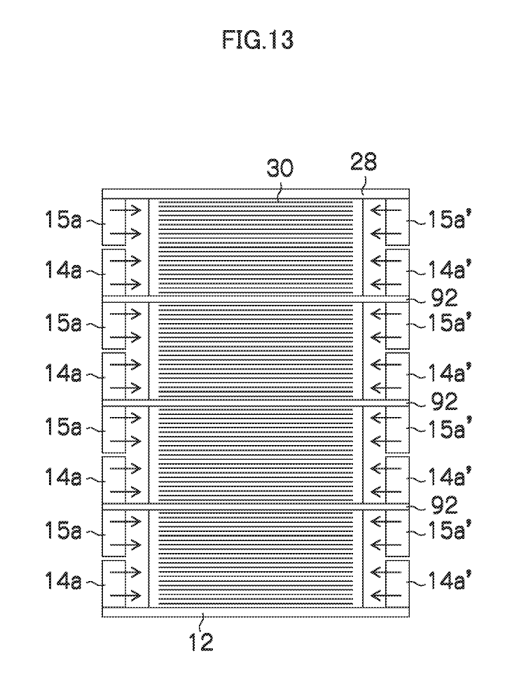

FIG. 13 is a schematic drawing showing a seasoning apparatus according to a fifth embodiment of the present invention. FIG. 13 is a schematic side view of a state during air blowing. In FIG. 13, elements which are the same as or similar to those in the composition described in FIGS. 4A to 4C are denoted with the same reference numerals, and description thereof is omitted here.

As shown in FIG. 13, it is possible to adopt a composition in which shelf plates 92 are arranged in the paper accommodating section on the table 12, and the sheets of paper 30 are stacked on a plurality of decks separately. FIG. 13 shows an example in which the paper accommodating section is divided into four decks by three shelf plates 92, and the number of shelf plates 92 can be suitably set to one or more, in accordance with the number of decks to be divided. By arranging n shelf plates 92 between the table 12 and the ceiling plate 28, a paper accommodating section having (n+1) decks is prepared.

For the device which puts the sheet of paper 30 in and out the respective decks of the paper accommodating section, it is possible to employ a commonly known structure having drawers, for example. Although the detailed structure is not shown in the drawings, it is possible to independently draw out each deck of the paper accommodating section and set a paper stack thereon. The lower-stage blowers 14 and the upper-stage blowers 15 similar to those shown in FIGS. 4A to 4C are arranged for each of the separate decks, and the difference of the air flow volume in the vertical direction can be controlled in respect of the paper stack on each deck. Looking at each deck in particular, the shelf plate 92 serves as a member corresponding to the table or the ceiling plate.

According to this mode, it is possible to pass a sufficient air flow over the sheets of paper stacked in lower levels, and therefore a large number of sheets of paper 30 can be seasoned in a short period of time.

### Description of Air Blowing Conditions Required for Seasoning

### <Conditions of Air Flow Volume>

In order to carry out seasoning quickly in respect of a large number of printed matters (a stack of printing paper sheets), it is necessary to blow an air flow between the sheets at all times at a prescribed air flow volume or above. Suitable air flow volume conditions for seasoning were clarified by means of evaluation experiments as described below.

### <Evaluation Method>

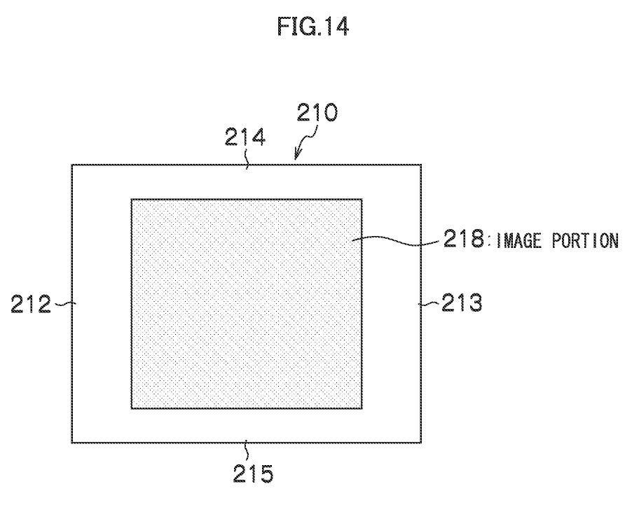

Step 1: As shown in FIG. 14, a solid image (an image portion denoted with reference numeral 218) was printed on the printing paper 210 by an inkjet recording apparatus, while appropriately leaving left-hand and right-hand margin portions 212 and 213 and upper and lower margin portions 214 and 215. Here, the remaining water volume contained in the image portion 218 after printing was approximately 2.5 g/m². A1 grade gloss coated paper made by Mitsubishi Paper Mills “Tokubishi Art double-side N” (product name) was used as the printing paper 210.

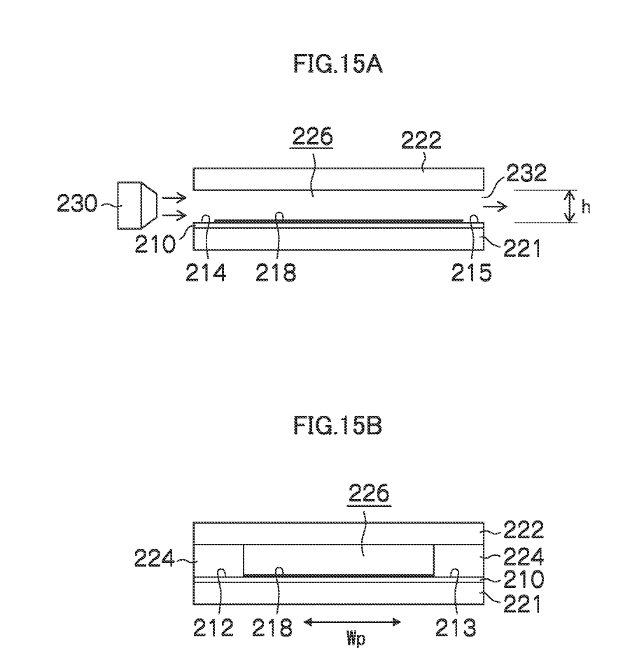

Step 2: After the printing, the printed paper (printed matter) was placed between two plates 221 and 222, and a gap 226 of a prescribed amount was produced with spacers 224 between the plates 221 and 222, as shown in FIGS. 15A and 15B. FIG. 15B is a diagram viewed from the side of a blower (air blowing device) 230 in FIG. 15A. More specifically, the printed paper 210 was placed with the image portion 218 facing upward on the plate 221, the spacers 224 of a prescribed thickness were placed on the left-hand and right-hand margin portions 212 and 213, and the plate 222 was placed on the spacers 224. The plate 221 was a member corresponding to a stacking table, and the plate 222 was a member corresponding to a ceiling plate. Thus, the gap of a prescribed height h was produced on the image portion 218 of the printed paper 210.

Step 3: Next, the blower 230 blew a flow of air into the gap 226. A Sanyo Electric Blower “San Ace B97 (9BMB24P2K01)” (product name) was used for the blower 230. The output air flow volume was controlled by controlling the input current of the blower.

The air flow speed v m/s was measured at an exit portion 232 of the air blowing path formed between the two plates 221 and 222 in FIG. 15A, and the air flow volume q per unit length of the paper in the breadthways direction thereof (Wp direction in FIG. 15B), q=h×v×60 m³/(min·m), was calculated using the height h of the gap 226 (corresponding to a gap between paper sheets). A Kanomax “Anemomaster Model 6004” (product name) was used for the air flow speed meter.

Step 4: After thus blowing the air flow for a prescribed period of time while maintaining the prescribed flow volume, the air blowing was halted, the paper 210 was removed and the amount of remaining water w g/m² was measured. The measurement method was as described below.

<<Water Amount Measurement Method>>

The amount of water contained in the printed paper 210 was measured by using a trace water content measurement apparatus (here, a Mitsubishi Chemical Analytech “CA-200” (product name) was used) on an extracted 3 cm by 3 cm measurement portion of the paper. The measured amount of water (g) was divided by the extracted surface area to derive the amount of water per unit surface area (g/m²).

The term “remaining amount of water” is defined as the amount of water remaining after depositing and drying ink droplets, minus the amount of water contained in the paper before printing. In other words, the amount of water originally contained in the printing paper itself is subtracted, and only the amount of water originating from the ink deposited by printing is considered. The amount of water originally contained in the paper is measured separately using unprinted paper.

Step 5: The air blowing time whereby the remaining amount of water w measured through the steps 1 to 4 becomes less than 0.5 g/m² is defined as the seasoning time.

<Evaluation Results>

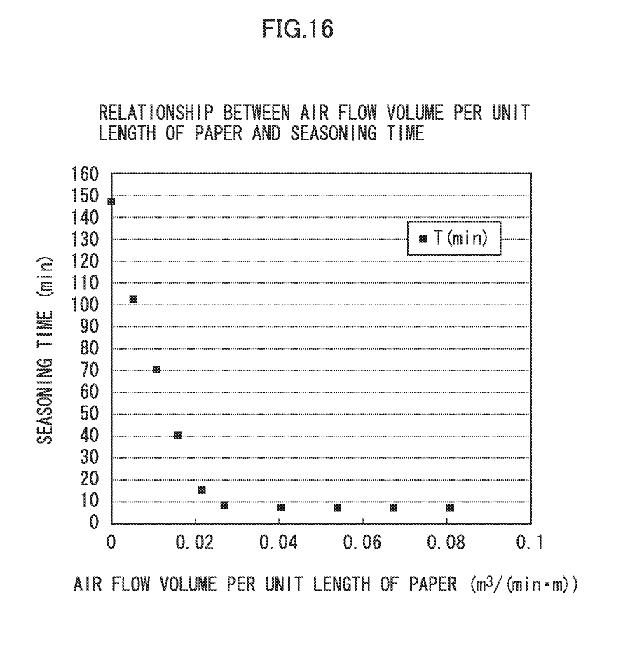

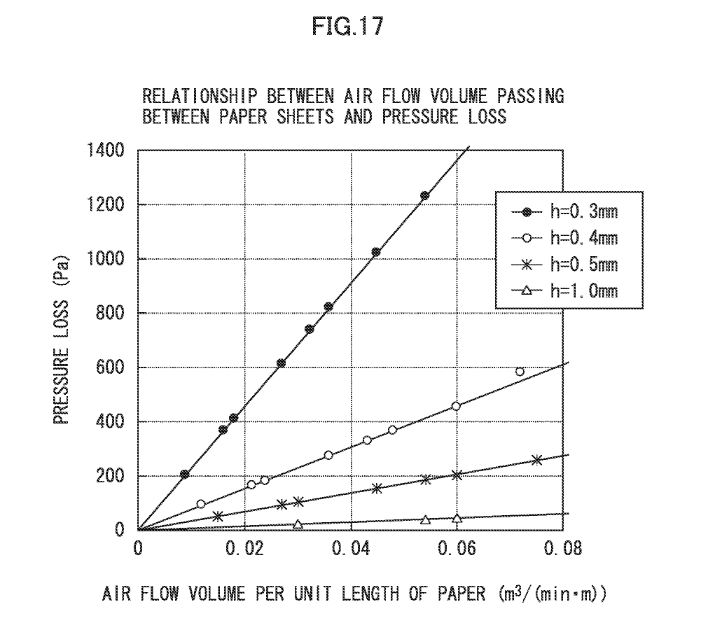

The relationship between the air flow volume per unit length of paper (air flow volume between sheets) and the seasoning time thus determined is shown in FIG. 16.

As FIG. 16 reveals, it was found that under conditions where the air flow volume q per unit length of paper was equal to or greater than 0.02 m³/(min·m), rapid seasoning can be carried out in 15 minutes or less.

### <Conditions of Air Flow Static Pressure>

In order to pass an air flow between a large number of printed matters (a stack of printed paper sheets), it is necessary to achieve a static pressure of the air flow that is sufficient to overcome the pressure loss. In general, a fluid passing between parallel plates has a pressure loss Pₗₒₛₛ (Pa) expressed as follows:

$${P}_{loss} = 12 η \frac{L}{{h}^{2}} V ,$$

where V (m/s) is a flow speed of the fluid, h (m) is a gap between the parallel plates, L (m) is a flow channel length, and η(Pa·s) is a viscosity of the fluid.

The gap between paper sheets h is principally governed by the number of sheets stacked on the table, and the distance between the table and the ceiling. The greater the gap h, the greater the extent to which the pressure loss can be reduced, but there are restrictions in relation to increase in the size of the apparatus and the liability of flapping or folding of the paper to occur due to the blowing of air, and in practice the gap of approximately h=0.5 mm is desirable.

In this case, in relation to the air flow static pressure required in the air blowing device, the required air volume has to be satisfied at a paper gap of approximately h=0.3 mm, taking account of non-uniformities in the air flow. FIG. 17 shows the relationship between the flow volume passing between the paper sheets and the pressure loss, supposing that the air blowing distance L is 469 mm, equal to the dimension of the short side of the half Kiku size (636 mm×469 mm), which is commonly used as printing paper.

From FIG. 17, it is clear that an air flow static pressure of 500 Pa is necessary in order to satisfy the air flow volume q per unit length q=0.02 m³/(min·m) at a gap of h=0.3 mm.

### Timing of Carrying Out Seasoning

There are no particular restrictions on the timing of carrying out seasoning, and seasoning is carried out at the following timings, for example.

(1) When single-side printing only is being performed, seasoning is carried out after printing on the single surface.
(2) When double-side printing is being performed, seasoning is carried out after printing the front surface and before printing the rear surface.
(3) When double-side printing is being performed, in addition to the case in (2), seasoning is also carried out after printing the rear surface.

### Embodiment of Application to Inkjet Printing System

A printing system which combines the seasoning apparatus shown in FIGS. 1 to 13 and an inkjet printing apparatus according to an embodiment of the present invention is now described.

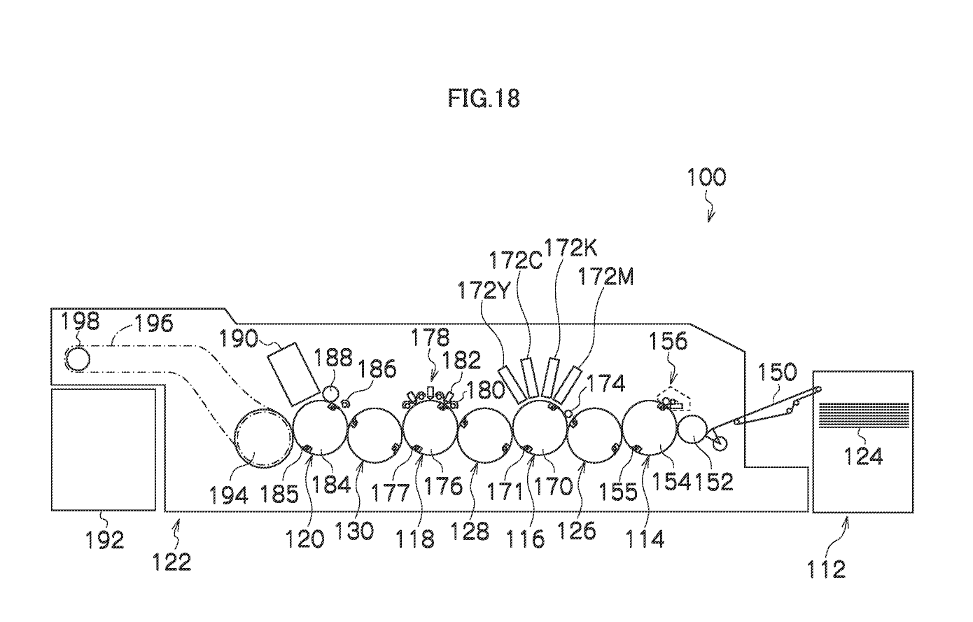

FIG. 18 is a structural diagram illustrating the configuration of an inkjet recording apparatus 100 according to an embodiment of the present invention. The inkjet recording apparatus 100 is an inkjet recording apparatus of a so-called pressure-drum direct image-formation system which records a desired color image on a recording medium (hereinafter also referred to as “paper”) 124 held on a pressure drum (an image formation drum 170) of an image formation unit 116 by ejecting and depositing droplets of ink of a plurality of colors from inkjet heads 172M, 172K, 172C and 172Y onto the recording medium 124. More specifically, the inkjet recording apparatus 100 is a recording apparatus of a on-demand type which adapts a two-liquids reaction (aggregation in the present embodiment) system in which treatment liquid (aggregation treatment liquid in the present embodiment) is applied onto the recording medium 124 prior to the deposition of the ink, so that the deposited ink reacts with the treatment liquid to form images on the recording medium 124.

The inkjet recording apparatus 100 includes a paper feed unit 112, a treatment liquid application unit 114, the image formation unit 116, a drying unit 118, a fixing unit 120, and a paper output unit 122 as the main components.

The seasoning apparatus 10 (or 80) described with reference to FIGS. 1 to 13 is disposed in the portion of an output tray 192 of the paper output unit 122 (see FIG. 18).

### <Paper Feed Unit>

The paper feed unit 112 feeds the recording medium 124 to the treatment liquid application unit 114. The recording medium 124 (paper sheets) is stacked in the paper feed unit 112. The paper feed unit 112 is provided with a paper feed tray 150, and the recording medium 124 is fed, sheet by sheet, from the paper feed tray 150 to the treatment liquid application unit 114.

In the inkjet recording apparatus 100 according to the present embodiment, it is possible to use recording media 124 of different types and various sizes as the recording medium 124. A mode can be adopted in which the paper feed unit 112 is provided with a plurality of paper trays (not illustrated) in which recording media of different types are respectively sorted and stacked, and the paper that is fed to the paper feed tray 150 from the paper trays is automatically switched, and a mode can also be adopted in which an operator selects or exchanges the paper tray in accordance with requirements. In the present embodiment, cut sheets of paper are used as the recording media 124, but it is also possible to cut paper to a required size from a continuous roll of paper and then supply this paper.

### <Treatment Liquid Application Unit>

The treatment liquid application unit 114 is a mechanism that applies the treatment liquid to the recording surface of the recording medium 124. The treatment liquid includes a coloring material aggregating agent that causes the aggregation of a coloring material (pigment in the present embodiment) included in the ink applied in the image formation unit 116, and the separation of the coloring material and a solvent in the ink is enhanced when the treatment liquid is brought into contact with the ink.

As shown in FIG. 18, the treatment liquid application unit 114 includes a paper transfer drum 152, a treatment liquid drum 154, and a treatment liquid application device 156. The treatment liquid drum 154 is a drum that holds and rotationally conveys the recording medium 124. The treatment liquid drum 154 is provided on the outer circumferential surface thereof with a hook-shaped holding device (gripper) 155, which holds the leading end of the recording medium 124 by gripping the recording medium 124 between the hook of the gripper 155 and the circumferential surface of the treatment liquid drum 154. The treatment liquid drum 154 may be provided with suction apertures on the outer circumferential surface thereof and connected to a suction device that performs suction from the suction apertures. As a result, the recording medium 124 can be tightly held on the outer circumferential surface of the treatment liquid drum 154.

The treatment liquid application device 156 is provided on the outside of the treatment liquid drum 154 opposite the outer circumferential surface thereof. The treatment liquid application device 156 includes: a treatment liquid container, in which the treatment liquid to be applied is held; an anilox roller, a part of which is immersed in the treatment liquid held in the treatment liquid container; and a rubber roller, which is pressed against the anilox roller and the recording medium 124 that is held by the treatment liquid drum 154, so as to transfer the treatment liquid metered by the anilox roller to the recording medium 124. The treatment liquid application device 156 can apply the treatment liquid onto the recording medium 124 while metering.

In the present embodiment, the application system using the roller is used; however, the present invention is not limited to this, and it is possible to employ a spraying method, an inkjet method, or other methods of various types.

The recording medium 124 that has been applied with the treatment liquid in the treatment liquid application unit 114 is transferred from the treatment liquid drum 154 through the intermediate conveyance unit 126 to the image formation drum 170 of the image formation unit 116.

### <Image Formation Unit>

The image formation unit 116 includes the image formation drum 170, a paper pressing roller 174 and the inkjet heads 172M, 172K, 172C and 172Y. Similar to the treatment liquid drum 154, the image formation drum 170 is provided on the outer circumferential surface thereof with a hook-shaped holding device (gripper) 171. The recording medium 124 held on the image formation drum 170 is conveyed in a state where the recording surface thereof faces outward, and inks are deposited on the recording surface by the inkjet heads 172M, 172K, 172C and 172Y.

The inkjet heads 172M, 172K, 172C and 172Y are recording heads (inkjet heads) of the inkjet system of the full line type that have a length corresponding to the maximum width of the image formation region in the recording medium 124. A nozzle row is formed on the ink ejection surface of the inkjet head. The nozzle row has a plurality of nozzles arranged therein for discharging ink over the entire width of the image recording region. Each of the inkjet heads 172M, 172K, 172C and 172Y is fixedly disposed so as to extend in the direction perpendicular to the conveyance direction (rotation direction of the image formation drum 170) of the recording medium 124.

Droplets of corresponding colored inks are ejected from the inkjet heads 172M, 172K, 172C and 172Y toward the recording surface of the recording medium 124 held tightly on the image formation drum 170, and thereby the ink comes into contact with the treatment liquid that has been heretofore applied on the recording surface by the treatment liquid application unit 114, the coloring material (pigment) dispersed in the ink is aggregated, and a coloring material aggregate is formed. Thus, the coloring material flow on the recording medium 124 is prevented, and an image is formed on the recording surface of the recording medium 124.

In the present embodiment, the CMYK standard color (four colors) configuration is described, but combinations of ink colors and numbers of colors are not limited to that of the present embodiment, and if necessary, light inks, dark inks, and special color inks may be added. For example, a configuration is possible in which inkjet heads are added that eject light inks such as light cyan and light magenta. The arrangement order of color heads is also not limited.

The recording medium 124 on which the image has been formed in the image formation unit 116 is transferred from the image formation drum 170 through an intermediate conveyance unit 128 to a drying drum 176 of the drying unit 118.

### <Drying Unit>

The drying unit 118 dries water included in the solvent separated by the coloring material aggregation action. As shown in FIG. 18, the drying unit includes the drying drum 176 and a solvent dryer 178.

Similar to the treatment liquid drum 154, the drying drum 176 is provided on the outer circumferential surface thereof with a hook-shaped holding device (gripper) 177, which can hold the recording medium 124 by gripping the leading end portion of the recording medium 124.

The solvent dryer 178 is disposed in a position facing the outer circumferential surface of the drying drum 176, and includes a plurality of halogen heaters 180, and a plurality of warm-air blow-out nozzles 182, each of which is arranged between adjacent two of the halogen heaters 180.

Each of the warm-air blow-out nozzles 182 is controlled to blow warm air at appropriate temperature at an appropriate blowing rate toward the recording medium 124, and each of the halogen heaters 180 is controlled to appropriate temperature, and it is thereby possible to implement various drying conditions.

The surface temperature of the drying drum 176 is set to 50° C. or above. By heating from the rear surface of the recording medium 124, drying is promoted and breaking of the image during fixing can be prevented. There are no particular restrictions on the upper limit of the surface temperature of the drying drum 176, but from the viewpoint of the safety of maintenance operations such as cleaning the ink adhering to the surface of the drying drum 176 (namely, preventing burns due to high temperature), desirably, the surface temperature of the drying drum 176 is not higher than 75° C. (and more desirably, not higher than 60° C.).

By holding the recording medium 124 in such a manner that the recording surface thereof is facing outward on the outer circumferential surface of the drying drum 176 (in other words, in a state where the recording surface of the recording medium 124 is curved in a convex shape), and drying while conveying the recording medium in rotation, it is possible to prevent the occurrence of wrinkles or floating up of the recording medium 124, and therefore drying non-uniformities caused by these phenomena can be prevented reliably.

The recording medium 124 which has been subjected to the drying treatment in the drying unit 118 is transferred from the drying drum 176 through an intermediate conveyance unit 130 to a fixing drum 184 of the fixing unit 120.

### <Fixing Unit>

The fixing unit 120 includes a fixing drum 184, a halogen heater 186, a fixing roller 188, and an inline sensor 190. Similar to the treatment liquid drum 154, the fixing drum 184 is provided on the outer circumferential surface thereof with a hook-shaped holding device (gripper) 185, which can hold the recording medium 124 by gripping the leading end portion of the recording medium 124. The recording medium 124 is conveyed by rotation of the fixing drum 184 in a state where the recording surface thereof faces outward, and the preheating by the halogen heater 186, the fixing treatment by the fixing roller 188 and the inspection by the inline sensor 190 are performed with respect to the recording surface.

The halogen heater 186 is controlled to a prescribed temperature (for example, 180° C.), by which the preheating is performed with respect to the recording medium 124.

The fixing roller 188 is a roller member which applies pressure and heat to the dried ink to melt and fix the self-dispersible polymer particles in the ink so as to transform the ink into the film. More specifically, the fixing roller 188 is arranged so as to be pressed against the fixing drum 184, and a nip roller is configured between the fixing roller 188 and the fixing drum 184. As a result, the recording medium 124 is squeezed between the fixing roller 188 and the fixing drum 184, nipped under a prescribed nip pressure (for example, 0.15 MPa), and subjected to fixing treatment.

Further, the fixing roller 188 is configured by a heating roller in which a halogen lamp is incorporated in a metal pipe, for example made from aluminum, having good thermal conductivity and the rollers are controlled to a prescribed temperature (for example 60° C. to 80° C.). Where the recording medium 124 is heated with the heating roller, thermal energy not lower than a Tg temperature (glass transition temperature) of a latex included in the ink is applied and latex particles are melted. As a result, fixing is performed by penetration into the projections-recessions of the recording medium 124, the projections-recessions of the image surface are leveled out, and gloss is obtained.

The fixing unit 120 in the embodiment shown in FIG. 18 is provided with the single fixing roller 188; however, it is possible that the fixing roller 188 has a configuration provided with a plurality of steps, depending on the thickness of image layer and Tg characteristic of latex particles.

On the other hand, the inline sensor 190 is a measuring device which measures the check pattern, moisture amount, surface temperature, gloss, and the like of the image fixed to the recording medium 124. A CCD sensor or the like can be used for the inline sensor 190.

With the fixing unit 120 of the above-described configuration, the latex particles located within a thin image layer formed in the drying unit 118 are melted by application of pressure and heat by the fixing roller 188. Thus, the latex particles can be reliably fixed to the recording medium 124. The surface temperature of the fixing drum 184 is set to 50° C. or above. Drying is promoted by heating the recording medium 124 held on the outer circumferential surface of the fixing drum 184 from the rear surface, and therefore breaking of the image during fixing can be prevented, and furthermore, the strength of the image can be increased by the effects of the increased temperature of the image.

Instead of the ink containing the high-boiling-point solvent and the polymer particles (thermoplastic resin particles), it is also possible to use an ink containing a monomer which can be polymerized and cured by exposure to ultraviolet (UV) light. In this case, the inkjet recording apparatus 100 includes a UV exposure unit for exposing the ink on the recording medium 124 to UV light, instead of the heat and pressure fixing unit including the heat roller (fixing roller 188). If using an ink containing an active light-curable resin, such as a UV-curable resin, then the inkjet recording apparatus 100 is thus provided with a device which irradiates the active light, such as a UV lamp or a UV laser diode (LD) array, instead of the fixing roller 188 for heat fixing.

### <Paper Output Unit>

As shown in FIG. 18, the paper output unit 122 is provided after the fixing unit 120. The paper output unit 122 includes the output tray 192, and a transfer drum 194, a conveying belt 196, and a tension roller 198 are provided between the output tray 192 and the fixing drum 184 of the fixing unit 120 so as to face the output tray 192 and the fixing drum 184. The recording medium 124 is fed by the transfer drum 194 onto the conveying belt 196 and outputted onto the output tray 192.

The seasoning apparatus 10 (or 80) described with reference to FIGS. 1 to 13 is used as the output tray 192, and serves as the seasoning device and also as the table on which the paper sheets after printing (printed matters) are stacked.

### <Other Units>

Although not shown in the drawings, the inkjet recording apparatus 100 in the present embodiment also includes, in addition to the above-described units: an ink storing and loading unit for supplying the inks to the inkjet heads 172M, 172K, 172C and 172Y; a treatment liquid supply unit for supplying the treatment liquid to the treatment liquid application unit 114; a head maintenance unit for cleaning the inkjet heads 172M, 172K, 172C and 172Y (e.g., wiping of the nozzle surface, purging, and suction for the nozzles); position determination sensors for determining the position of the recording medium 124 in the medium conveyance path; and temperature sensors for measuring temperature in the respective parts of the inkjet recording apparatus 100.

### <Adaptation to Double-Side Printing>

When carrying out double-side printing in the inkjet recording apparatus 100 shown in FIG. 18, seasoning is carried out for a prescribed period of time by the seasoning apparatus 10 (or 80), after printing on one surface (the front surface) of the paper. The stack of paper which has undergone a seasoning process is then returned to the paper supply unit 112, and rear surface printing is carried out.

By this means, it is possible to achieve satisfactory double-side printing in a short period of time, without the occurrence of front/rear registration errors, or the like.

Furthermore, in the inkjet recording apparatus 100 shown in FIG. 18, it is also possible to adopt a composition in which a plurality of seasoning apparatuses 10 (or 80) are provided for use in the output tray 192 and the seasoning apparatuses 10 (or 80) can be moved between the paper output section 122 and the paper supply unit 112.

For example, it is possible to employ a composition in which the seasoning apparatuses 10 (or 80) can travel by being provided with casters, and it is also possible to adopt a composition where the seasoning apparatuses 10 (or 80) travel on rails.

While a first seasoning apparatus is seasoning a stack of printed matters, another (second) seasoning apparatus is set in the paper output section 122 and receives printed matters which are newly printed and output. The stack of paper that has completed seasoning by the first seasoning apparatus is supplied to the paper supply unit 112.

When a prescribed number of printed matters have been stacked in the second seasoning apparatus, the second seasoning apparatus is withdrawn from the paper supply unit 122 and starts a seasoning operation. A third seasoning apparatus or the first seasoning apparatus that has become empty is set in the paper supply unit 122 and printing is continued. By composing the system by using the plurality of seasoning apparatuses in rotation in this way, it is possible to achieve automated operation, as well as being able to produce a large number of printed matters with good efficiency.

### Ink

The ink used in the present embodiment is aqueous ink containing water as a solvent, and more specifically, for example, an aqueous pigment ink that contains the following materials insoluble to the solvent (water): pigment particles as the coloring material, and the polymer particles.

It is desirable that the concentration of the solvent-insoluble materials in the ink is not less than 1 wt % and not more than 20 wt %, taking account of the fact that the viscosity of the ink suitable for ejection is 20 mPa·s or lower. It is more desirable that the concentration of the pigment in the ink is not less than 4 wt %, in order to obtain good optical density in the image.

It is desirable that the surface tension of the ink is not less than 20 mN/m and not more than 40 mN/m, taking account of ejection stability in the ink ejection head.

The coloring material in the ink may be pigment or a combination of pigment and dye. From the viewpoint of the aggregating characteristics when the ink comes into contact with the treatment liquid, a dispersed pigment in the ink is desirable for more effective aggregation. Desirable pigments include: a pigment dispersed by a dispersant, a self-dispersing pigment, a pigment in which the pigment particle is coated with a resin (hereinafter referred to as “microcapsule pigment”), and a polymer grafted pigment. Moreover, from the viewpoint of the aggregating characteristics of the coloring material, it is more desirable that the coloring material is modified with a carboxyl group having a low degree of disassociation.

It is desirable in the present embodiment that the colored ink liquid contains polymer particles that do not contain any colorant, as a component for reacting with the treatment liquid. The polymer particles can improve the image quality by strengthening the ink viscosity raising action and the aggregating action through reaction with the treatment liquid. In particular, a highly stable ink can be obtained by adding anionic polymer particles to the ink.

By using the ink containing the polymer particles that produce the viscosity raising action and the aggregating action through reaction with the treatment liquid, it is possible to increase the quality of the image, and at the same time, depending on the type of polymer particles, the polymer particles may form a film on the recording medium, and therefore beneficial effects can be obtained in improving the wear resistance and the waterproofing characteristics of the image.

The method of dispersing the polymer particles in the ink is not limited to adding an emulsion of the polymer particles to the ink, and the resin may also be dissolved, or included in the form of a colloidal dispersion, in the ink.

The polymer particles may be dispersed by using an emulsifier, or the polymer particles may be dispersed without using any emulsifier. For the emulsifier, a surface active agent of low molecular weight is generally used, and it is also possible to use a surface active agent of high molecular weight. It is also desirable to use a capsule type of polymer particles having an outer shell composed of acrylic acid, methacrylic acid, or the like (core-shell type of polymer particles in which the composition is different between the core portion and the outer shell portion).

Examples of the resin component added as the resin particles to the ink include: an acrylic resin, a vinyl acetate resin, a styrene-butadiene resin, a vinyl chloride resin, an acryl-styrene resin, a butadiene resin, and a styrene resin.

In order to make the polymer particles have high speed aggregation characteristics, it is desirable that the polymer particles contain a carboxylic acid group having a low degree of disassociation. Since the carboxylic acid group is readily affected by change of pH, then the polymer particles containing the carboxylic acid group easily change the state of the dispersion and have high aggregation characteristics.

The change in the dispersion state of the polymer particles caused by change in the pH can be adjusted by means of the component ratio of the polymer particle having a carboxylic acid group, such as ester acrylate, or the like, and it can also be adjusted by means of an anionic surfactant which is used as a dispersant.

Desirably, the resin constituting the polymer particles is a polymer that has both of a hydrophilic part and a hydrophobic part. By incorporating a hydrophobic part, the hydrophobic part is oriented toward to the inner side of the polymer particle, and the hydrophilic part is oriented efficiently toward the outer side, thereby having the effect of further increasing the change in the dispersion state caused by change in the pH of the liquid. Therefore, aggregation can be performed more efficiently.

Moreover, two or more types of polymer particles may be used in combination in the ink.

Examples of the pH adjuster added to the ink in the present embodiment include an organic base and an inorganic alkali base, as a neutralizing agent. In order to improve storage stability of the ink for inkjet recording, the pH adjuster is desirably added in such a manner that the ink for inkjet recording has the pH of 6 through 10.

It is desirable in the present embodiment that the ink contains a water-soluble organic solvent, from the viewpoint of preventing nozzle blockages in the ejection head due to drying.

Examples of the water-soluble organic solvent include a wetting agent and a penetrating agent.

Examples of the water-soluble organic solvent in the ink are: polyhydric alcohols, polyhydric alcohol derivatives, nitrous solvents, monohydric alcohols, and sulfurous solvents.

Apart from the foregoing, according to requirements, it is also possible that the ink contains a pH buffering agent, an anti-oxidation agent, an antibacterial agent, a viscosity adjusting agent, a conductive agent, an ultraviolet absorbing agent, or the like.

Moreover, it is also possible that the ink contains thermoplastic resin particles. By making the ink contain the thermoplastic resin, film formation progresses during the heating step and the image strength can be improved. If the thermoplastic resin is contained in the ink, it is more beneficial to carry out a fixing step of heating and pressing the image, in addition to the heating process during drying.

Furthermore, by making the ink contain the ultraviolet-curable monomer, it possible to improve the strength of the image by irradiating ultraviolet light onto the image in a fixing unit including an ultraviolet irradiation lamp, or the like, after the water has been evaporated off sufficiently in the drying unit, thereby curing and polymerizing the ultraviolet-curable monomer.

### Treatment Liquid

It is desirable in the present embodiment that the treatment liquid (aggregating treatment liquid) has effects of generating aggregation of the pigment and the polymer particles contained in the ink by producing a pH change in the ink when coming into contact with the ink.

Specific examples of the contents of the treatment liquid are: polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furan carboxylic acid, pyridine carboxylic acid, cumaric acid, thiophene carboxylic acid, nicotinic acid, derivatives of these compounds, and salts of these.

A treatment liquid having added thereto a polyvalent metal salt or a polyallylamine is the preferred examples of the treatment liquid. The aforementioned compounds may be used individually or in combinations of two or more thereof.

From the standpoint of aggregation ability with the ink, the treatment liquid preferably has a pH of 1 to 6, more preferably a pH of 2 to 5, and even more preferably a pH of 3 to 5.

From the standpoint of preventing the nozzles of inkjet heads from being clogged by the dried treatment liquid, it is preferred that the treatment liquid includes an organic solvent capable of dissolving water and other additives. A wetting agent and a penetrating agent are included in the organic solvent capable of dissolving water and other additives.

In order to improve fixing ability and abrasive resistance, the treatment liquid may further include a resin component. Any resin component may be employed, provided that the ejection ability from a head is not degraded when the treatment liquid is ejected by an inkjet system and also provided that the treatment liquid will have high stability in storage. Thus, water-soluble resins and resin emulsions can be freely used.

Apart from the foregoing, according to requirements, it is also possible that the treatment liquid contains a pH buffering agent, an anti-oxidation agent, an antibacterial agent, a viscosity adjusting agent, a conductive agent, an ultraviolet absorbing agent, or the like.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A printing paper seasoning apparatus, comprising:
a table on which a plurality of sheets of printing paper are placed in a stack, curl having occurred in the sheets, a direction to which convex sides of the curled sheets face being taken as a curl direction;
a ceiling plate which is arranged over the table to face the table and covers an upper side of the stack on the table, a paper accommodating section being defined between the table and the ceiling plate;
an air blowing device which has an air blowing port at a lateral side of the paper accommodating section and blows an air flow to the paper accommodating section through the air blowing port;
a side plate which is arranged at the lateral side of the paper accommodating section and closes a periphery of the air blowing port of the air blowing device; and
an air flow volume difference control device which changes an air flow volume difference in a vertical direction of the air flow blown from the air blowing device during air blowing toward the sheets of printing paper placed in the paper accommodating section, wherein:
the air flow volume difference control device varies and controls a relationship between a volume of the air flow supplied to an upper portion of the paper accommodating section and a volume of the air flow supplied to a lower portion of the paper accommodating section; and
the air flow volume difference control device controls the air flow volume difference in such a manner that
during an initial period of the air blowing, the volume of the air flow supplied to one of the upper portion and the lower portion on a side opposite from the curl direction is greater than the volume of the air flow supplied to the other of the upper portion and the lower portion on a side of the curl direction, and
during a latter period of the air blowing, compared with the initial period of the air blowing, the volume of the air flow supplied to the one of the upper portion and the lower portion on the side opposite from the curl direction is reduced and the volume of the air flow supplied to the other of the upper portion and the lower portion on the side of the curl direction is increased.

2. The printing paper seasoning apparatus as defined in claim 1, wherein:
the curl direction is a downward direction; and
the air flow volume difference control device controls the air flow volume difference in such a manner that
during the initial period of the air blowing, the volume of the air flow supplied to the upper portion is greater than the volume of the air flow supplied to the lower portion, and
during the latter period of the air blowing, compared with the initial period of the air blowing, the volume of the air flow supplied to the upper portion is reduced and the volume of the air flow supplied to the lower portion is increased.

3. The printing paper seasoning apparatus as defined in claim 1, wherein:
the curl direction is an upward direction; and
the air flow volume difference control device controls the air flow volume difference in such a manner that
during the initial period of the air blowing, the volume of the air flow supplied to the lower portion is greater than the volume of the air flow supplied to the upper portion, and
during the latter period of the air blowing, compared with the initial period of the air blowing, the volume of the air flow supplied to the lower portion is reduced and the volume of the air flow supplied to the upper portion is increased.

4. The printing paper seasoning apparatus as defined in claim 1, wherein:
the air blowing device includes a plurality of air blowers arranged along the vertical direction; and
the air flow volume difference control device controls an air blow output of each of the air blowers.

5. The printing paper seasoning apparatus as defined in claim 1, wherein:
the air flow volume difference control device includes an air flow guide member which restricts a flow direction of the air flow blown from the air blowing device; and
the air flow volume difference control device changes the air flow volume difference by altering a shape of the air flow guide member with respect to the air flow blown from the air blowing device.

6. The printing paper seasoning apparatus as defined in claim 5, wherein:
the air flow guide member is rotatably supported; and
the air flow volume difference control device changes the air flow volume difference by changing an angle of the air flow guide member with respect to the air flow by turning the air flow guide member.

7. The printing paper seasoning apparatus as defined in claim 1, wherein:
the air flow volume difference control device includes a shutter member which opens and closes a portion of the side plate; and
the air flow volume difference control device changes the air flow volume difference by altering a closing ratio of the shutter member.

8. The printing paper seasoning apparatus as defined in claim 1, wherein at least one of an air blowing volume and an air blowing time of the air blowing device is controlled in accordance with attributes of the printing paper.

9. The printing paper seasoning apparatus as defined in claim 1, wherein at least one of an air blowing volume and an air blowing time of the air blowing device is controlled in accordance with an amount of ink deposited on the sheets of printing paper.

10. The printing paper seasoning apparatus as defined in claim 1, further comprising:
a curl determination device which determines a state of the curl having occurred in the sheets of printing paper,
wherein at least one of an air blowing volume and an air blowing time of the air blowing device is controlled in accordance with determination results of the curl determination device.

11. The printing paper seasoning apparatus as defined in claim 1, wherein a static pressure of the air flow blown from the air blowing device is at least 500 Pa.

12. The printing paper seasoning apparatus as defined in claim 1, further comprising at least one shelf plate member with which the sheets of the printing paper are placed dividedly in a plurality of stacks.

13. An inkjet recording apparatus, comprising a paper output section which includes the printing paper seasoning apparatus as defined in claim 1.

14. A method of seasoning printing paper in a printing paper seasoning apparatus which comprises: a table on which a plurality of sheets of printing paper are placed in a stack; a ceiling plate which is arranged over the table to face the table and covers an upper side of the stack on the table, a paper accommodating section being defined between the table and the ceiling plate; an air blowing device which has an air blowing port at a lateral side of the paper accommodating section and blows an air flow to the paper accommodating section through the air blowing port; a side plate which is arranged at the lateral side of the paper accommodating section and closes a periphery of the air blowing port of the air blowing device; and an air flow volume difference control device which changes an air flow volume difference in a vertical direction of the air flow blown from the air blowing device during air blowing toward the sheets of printing paper placed in the paper accommodating section and which varies and controls a relationship between a volume of the air flow supplied to an upper portion of the paper accommodating section and a volume of the air flow supplied to a lower portion of the paper accommodating section, the method comprising the steps of:
placing a plurality of sheets of printing paper in the paper accommodating section, curl having occurred in the sheets, a direction to which convex sides of the curled sheets face being taken as a curl direction; and
performing air blowing toward the sheets of printing paper placed in the paper accommodating section by the air blowing device while controlling the air flow volume difference by the air flow volume difference control device in such a manner that
during an initial period of the air blowing, the volume of the air flow supplied to one of the upper portion and the lower portion on a side opposite from the curl direction is greater than the volume of the air flow supplied to the other of the upper portion and the lower portion on a side of the curl direction, and
during a latter period of the air blowing, compared with the initial period of the air blowing, the volume of the air flow supplied to the one of the upper portion and the lower portion on the side opposite from the curl direction is reduced and the volume of the air flow supplied to the other of the upper portion and the lower portion on the side of the curl direction is increased.

15. The method as defined in claim 14, wherein:
the curl direction is a downward direction; and
in the step of performing the air blowing, the air flow volume difference is controlled in such a manner that
during the initial period of the air blowing, the volume of the air flow supplied to the upper portion is greater than the volume of the air flow supplied to the lower portion, and
during the latter period of the air blowing, compared with the initial period of the air blowing, the volume of the air flow supplied to the upper portion is reduced and the volume of the air flow supplied to the lower portion is increased.

16. The method as defined in claim 14, wherein:
the curl direction is an upward direction; and
in the step of performing the air blowing, the air flow volume difference is controlled in such a manner that
during the initial period of the air blowing, the volume of the air flow supplied to the lower portion is greater than the volume of the air flow supplied to the upper portion, and
during the latter period of the air blowing, compared with the initial period of the air blowing, the volume of the air flow supplied to the lower portion is reduced and the volume of the air flow supplied to the upper portion is increased.

17. The method as defined in claim 14, wherein in the step of performing the air blowing, at least one of an air blowing volume and an air blowing time of the air blowing device is controlled in accordance with attributes of the printing paper.

18. The method as defined in claim 14, wherein in the step of performing the air blowing, at least one of an air blowing volume and an air blowing time of the air blowing device is controlled in accordance with an amount of ink deposited on the sheets of printing paper.

19. The method as defined in claim 14, further comprising the step of:
determining a state of the curl having occurred in the sheets of printing paper,
wherein in the step of performing the air blowing, at least one of an air blowing volume and an air blowing time of the air blowing device is controlled in accordance with determination results obtained in the step of determining the state of the curl.
